(19) United States
(12) Patent Application Publication
(10) Pub. No.: US 2023/0410845 A1
(43) Pub. Date: Dec. 21, 2023

(54) MAGNETIC RECORDING MEDIUM, MAGNETIC RECORDING CARTRIDGE, AND RECORDING/REPRODUCING APPARATUS

(71) Applicant: Sony Group Corporation, Tokyo (JP)

(72) Inventors: Minoru YAMAGA, Tokyo (JP); Takahiro TAKAYAMA, Tokyo (JP)

(21) Appl. No.: 18/035,241

(22) PCT Filed: Oct. 27, 2021
(86) PCT No.: PCT/JP2021/039610

§ 371 Date: May 3, 2023

(30) Foreign Application Priority Data
Nov. 9, 2020 (JP) 2020-186854

(51) Int. Cl. G11B 23/037; G11B 5/667; G11B 5/706

(52) U.S. Cl. CPC G11B 23/037; G11B 5/667; G11B 5/706; G11B 5/84

(57) ABSTRACT

There is provided a magnetic recording medium that enables stable traveling upon recording processing and reproduction processing. The magnetic recording medium is a magnetic recording medium having a tape-like shape. The magnetic recording medium includes a substrate and a magnetic layer provided on the substrate. When a weight of the magnetic recording medium is set to one, a rate of a moisture content contained in the magnetic recording medium in a state of being stored in an environment of 23° C. and 45% RH for 24 hours or more is 0.64 wt % or less.

### TECHNICAL FIELD

The present disclosure relates to a magnetic recording medium, and a magnetic recording cartridge and a recording/reproducing apparatus which include the magnetic recording medium.

### BACKGROUND ART

A tape-like magnetic recording medium has been widely used to store electronic data. For example, PTL 1 proposes a magnetic recording medium having excellent electromagnetic conversion characteristics in a high-temperature environment.

### CITATION LIST

### Patent Literature

PTL 1: International Publication No. WO2018/203468

### SUMMARY OF THE INVENTION

Incidentally, such a tape-like magnetic recording medium is required to be able to stably travel when performing recording on a magnetic recording medium or when performing reproducing from the magnetic recording medium.

It is therefore desirable to provide a magnetic recording medium that is able to stably travel even in a case where a change in a temperature/humidity environment occurs.

A magnetic recording medium according to an embodiment of the present disclosure has a tape-like shape, and includes a substrate and a magnetic layer provided on the substrate. When a weight of the magnetic recording medium is set to one, a rate of a moisture content contained in the magnetic recording medium in a state of being stored in an environment of 23° C. and 45% RH for 24 hours or more is 0.64 wt % or less.

The magnetic recording medium according to an embodiment of the present disclosure has the above-described configuration. Thus, it is possible to suppress a variation in a relative humidity even in a case where a temperature environment changes rapidly.

### BRIEF DESCRIPTION OF THE DRAWINGS

FIG. 1 is a schematic view of a configuration example of a magnetic recording cartridge according to a first embodiment of the present disclosure.

FIG. 2 is a cross-sectional view of a magnetic recording medium according to the first embodiment of the present disclosure.

FIG. 3A is an explanatory outline view of a layout of data bands and servo bands in the magnetic recording medium illustrated in FIG. 2.

FIG. 3B is an enlarged explanatory outline view of the data band illustrated in FIG. 3A.

FIG. 4 is a schematic cross-sectional view of a cross-sectional structure of an ε-iron oxide particle included in a magnetic layer illustrated in FIG. 2.

FIG. 5 is a graph illustrating an example of an SFD curve of the magnetic recording medium illustrated in FIG. 2.

FIG. 6 is a schematic outline view of an appearance of a measuring apparatus used for measuring a width of the magnetic recording medium.

FIG. 7 is a schematic outline view that describes a method for measuring a dynamic friction coefficient.

FIG. 8 is a schematic view of a configuration example of a recording/reproducing apparatus provided with the magnetic recording cartridge in FIG. 1.

FIG. 9 is a cross-sectional view of an ε-iron oxide particle according to a modification example of the first embodiment.

FIG. 10 is a cross-sectional view of a magnetic recording medium according to another modification example of the first embodiment.

FIG. 11 is a cross-sectional view of a magnetic recording medium according to a second embodiment of the present disclosure.

FIG. 12 is a schematic view of a configuration example of a sputtering apparatus used for manufacturing the magnetic recording medium illustrated in FIG. 11.

FIG. 13 is a schematic view of an outline configuration of an environmental testing apparatus used in Examples of the present disclosure.

FIG. 14 is a characteristic diagram illustrating changes in a temperature/humidity environment of a constant temperature reservoir illustrated in FIG. 13, in Examples.

FIG. 15 is a schematic view of a configuration example of a magnetic recording cartridge as a modification example of the present disclosure.

### MODES FOR CARRYING OUT THE INVENTION

Hereinafter, some embodiments of the present disclosure are described in detail with reference to the drawings. It is to be noted that the embodiments described below are those illustrating representative embodiments of the present technology and the present technology is not limited to the following embodiments.

It is to be noted that description is given in the following order.
1. Overview of Present Technology
2. First Embodiment (An example of a magnetic recording cartridge including a coated magnetic recording medium)
   2-1. Configuration of Magnetic Recording Cartridge
   2-2. Configuration of Magnetic Recording Medium
   2-3. Method of Manufacturing Magnetic Recording Medium
   2-4. Recording/Reproducing Apparatus
   2-5. Effects
   2-6. Modification Examples
3. Second Embodiment (An example of a magnetic recording cartridge including a sputtered magnetic recording medium)
   3-1. Configuration of Magnetic Recording Cartridge
   3-2. Configuration of Magnetic Recording Medium
   3-3. Configuration of Sputtering Apparatus
   3-4. Method of Manufacturing Magnetic Recording Medium
   3-5. Effects
   3-6. Modification Example
4. Examples

### 1. OVERVIEW OF PRESENT TECHNOLOGY

First, description is given of the history leading to the creation of the technology of the present disclosure. In recent years, it is required to further increase a recording capacity per magnetic recording cartridge. For example, in order to increase the recording capacity, it is conceivable to make a magnetic recording medium (e.g., a magnetic recording tape) included in a magnetic recording cartridge thinner (reduce the total thickness thereof) and to increase a tape length per magnetic recording cartridge.

However, a higher capacity of the magnetic recording medium and a thinner dimension as well as increased planarization thereof make the magnetic recording medium more susceptible to a change in a surrounding temperature/humidity environment. For example, in a case where a temperature changes rapidly from a room temperature (e.g., 23° C.) to a low temperature (e.g., 5° C.), a magnetic recording medium having a certain degree of thickness is able to absorb moisture in a surrounding environment. However, a thinned magnetic recording medium is not able to sufficiently absorb the moisture in a surrounding environment, which may possibly cause condensation on a surface thereof. When such condensation occurs on the surface of the magnetic recording medium, for example, stiction between the surface of the magnetic recording medium and the magnetic head occurs when being used in a recording/reproducing apparatus, which prevents the magnetic recording medium from stably traveling. In addition, it is considered that planarization of the surface of the magnetic recording medium brings the surface of the magnetic recording medium and the magnetic head into a state where the stiction is more likely to occur therebetween.

Therefore, the present applicant proposes optimizing a moisture amount of the magnetic recording medium to cause the magnetic recording medium to absorb and remove the moisture even in a case where an environmental temperature changes, thereby stabilizing a relative humidity of the magnetic recording medium in a traveling environment and thus suppressing occurrence of condensation.

### 2. FIRST EMBODIMENT (AN EXAMPLE OF A MAGNETIC RECORDING CARTRIDGE INCLUDING A COATED MAGNETIC RECORDING MEDIUM)

### 2-1. Configuration of Magnetic Recording Cartridge 1

First, description is given, with reference to FIG. 1, of a configuration of a magnetic recording cartridge 1 according to a first embodiment of the present disclosure. FIG. 1 is a schematic view of an example of the magnetic recording cartridge 1. The magnetic recording cartridge 1 includes a cartridge case 2 and a reel 3 provided therein. A tape-like magnetic recording medium 10 is wound around the reel 3. When performing recording on the magnetic recording medium 10 and when performing reproducing from the magnetic recording medium 10, the magnetic recording medium 10 travels along its own longitudinal direction. The magnetic recording medium 10 is preferably used in a recording/reproducing apparatus including a ring-type head as a recording head, for example.

### 2-2. Configuration of Magnetic Recording Medium 10

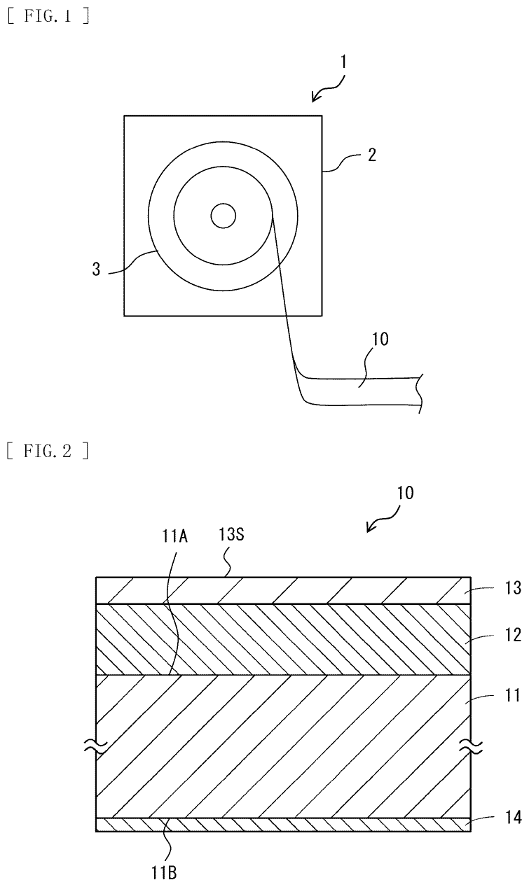

FIG. 2 schematically illustrates a cross-sectional configuration example of the magnetic recording medium 10. As illustrated in FIG. 2, the magnetic recording medium 10 includes a stacked structure in which a plurality of layers are stacked. Specifically, the magnetic recording medium 10 includes an elongated tape-like substrate 11, an underlayer 12 provided on one main surface 11A of the substrate 11, a magnetic layer 13 provided on the underlayer 12, and a back layer 14 provided on another main surface 11B of the substrate 11. The magnetic layer 13 has a surface 13S on which a magnetic head is to travel while being in contact with the surface 13S. It is to be noted that the underlayer 12 and the back layer 14 are provided as needed, or may be omitted.

When the weight of the magnetic recording medium 10 is set to one, the rate of moisture content contained in the magnetic recording medium 10 is favorably 0.2 wt % or more and 0.64 wt % or less, for example. The rate of the moisture content contained in the magnetic recording medium 10 is particularly preferably 0.3 wt % or less. As used herein, the rate of the moisture content contained in the magnetic recording medium 10 is a rate of moisture content contained in the magnetic recording medium 10 in a stabilized state in an environment of a temperature of 23° C. and a relative humidity of 45% RH. That is, the rate of the moisture content contained in the magnetic recording medium 10 does not refer to a moisture content rate for a magnetic recording medium in a dried state in a temporary special environment, e.g., in a high-temperature vacuum environment. The rate of the moisture content contained in the magnetic recording medium 10 means a moisture content rate in the magnetic recording medium 10 placed in an environment of a temperature of 23° C. and a relative humidity of 45% RH for at least 24 hours. In addition, an average thickness of the magnetic recording medium 10 is, for example, 4.0 μm or more and 5.8 μm or less, and particularly favorably 4.0 μm or more and 5.3 μm or less. In addition, the total surface of a surface of the magnetic recording medium 10 (hereinafter, simply referred to as the total surface area of the magnetic recording medium 10) on a side of the magnetic layer 13 wound around the reel 3 of the magnetic recording cartridge 1 is, for example, 6.3 m² or more and 25 m² or less, more preferably 12 m² or more and 25 m² or less, and still more preferably 15 m² or more and 25 m² or less. It is to be noted that the total length of the magnetic recording medium 10 wound around the reel 3 of the magnetic recording cartridge 1 is, for example, 1000 m. The total surface area of the magnetic recording medium 10 refers to the total sum of the area on a side of the surface where the magnetic layer 13 is provided as viewed from the substrate 11, not including the area on a side of the surface where the back layer 14 is provided as viewed from the substrate 11. Specifically, the total surface area is determined by (total length of the magnetic recording medium 10 included in the magnetic recording cartridge 1)×(width of the magnetic recording medium 10). It is to be noted that, the total surface area of the magnetic recording medium 10 as used herein does not include an area of the surface, of the magnetic recording medium 10, corresponding to a region where the magnetic layer 13 is not formed.

### (Substrate 11)

The substrate 11 is a non-magnetic supporting member that supports the underlayer 12 and the magnetic layer 13. The substrate 11 has an elongated film shape. The upper limit value of the average thickness of the substrate 11 is preferably 4.2 μm or less, and more preferably 4.0 μm or less. When the upper limit value of the average thickness of the substrate 11 is 4.2 μm or less, it is possible to increase a recordable recording capacity of one magnetic recording cartridge 1, as compared with a common magnetic recording medium. The lower limit value of the average thickness of the substrate 11 is preferably 3 μm or more, more preferably 3.2 μm or more. When the lower limit value of the average thickness of the substrate 11 is 3 μm or more, it is possible to suppress a decrease in strength of the substrate 11.

The average thickness of the substrate 11 is determined as follows. First, the magnetic recording medium 10 having a width of ½ inches is prepared, and cut into a length of 250 mm to produce a sample. Thereafter, the layers of the sample except the substrate 11, i.e., the underlayer 12, the magnetic layer 13, and the back layer 14 are removed with a solvent, such as MEK (methyl ethyl ketone) or dilute hydrochloric acid. Next, a measuring apparatus, Laser Hologauge (LGH-110C) manufactured by Mitutoyo Corporation, is used to measure the thickness of the substrate 11 as the sample at five points or more. Thereafter, these measurement values are simply averaged (arithmetically averaged) to calculate an average thickness of the substrate 11. It is to be noted that the measurement points are randomly selected on the sample.

The substrate 11 includes polyesters as a primary constituent, for example. Alternatively, the substrate 11 may include PEEK (polyether ether ketone) as the primary constituent. The substrate 11 may include at least one of polyolefins, cellulose derivatives, vinyl-based resins, or other polymeric resins, in addition to polyesters or PEEK. Ina case where the substrate 11 includes two or more of the materials described above, the two or more materials may be mixed, copolymerized, or stacked.

The polyesters included in the substrate 11 include, for example, at least one of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-oxybenzoate), or polyethylene bisphenoxycarboxylate.

The polyolefins included in the substrate 11 include, for example, at least one of PE (polyethylene) or PP (polypropylene). The cellulose derivatives include, for example, at least one of cellulose diacetate, cellulose triacetate, CAB (cellulose acetate butyrate), or CAP (cellulose acetate propionate). The vinyl-based resins include, for example, at least one of PVC (polyvinyl chloride) or PVDC (polyvinylidene chloride).

Other polymeric resins included in the substrate 11 include, for example, at least one of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, for example, Zylon (Registered Trademark)), polyether, PEK (polyether ketone), polyether-ester, PES (polyether sulfone), PEI (polyetherimide), PSF (polysulfone), PPS (polyphenylene sulfide), PC (polycarbonate), PAR (polyarylate), or PU (polyurethane).

### (Magnetic Layer 13)

The magnetic layer 13 is a recording layer to record signals. The magnetic layer 13 includes, for example, magnetic powders, a binder, and a lubricant. The magnetic layer 13 may further include an additive, such as conductive particles, an abrasive, and a rust inhibitor, as needed.

The surface 13S of the magnetic layer 13 has an arithmetic mean roughness Ra of 2.5 nm or less, preferably 2.2 nm or less, and more preferably 1.9 nm or less. When the arithmetic mean roughness Ra is 2.5 nm or less, it is possible to obtain excellent electromagnetic conversion characteristics. The lower limit value of the arithmetic mean roughness Ra of the surface 13S of the magnetic layer 13 may be preferably 1.0 nm or more, more preferably 1.2 nm or more, and still more preferably 1.4 nm or more. When the lower limit value of the arithmetic mean roughness Ra of the surface 13S of the magnetic layer 13 is 1.0 nm or more, it is possible to suppress a decrease in traveling performance due to an increase in friction.

The arithmetic mean roughness Ra of the surface 13S is calculated as follows. First, the surface of the magnetic layer 13 is observed using an AFM (Atomic Force Microscope) to obtain an AFM image of 40 μm×40 μm. Nano Scope IIIa D3100, manufactured by Digital Instruments Co., Ltd., is used as the AFM, and a cantilever made of silicon single crystal is used. The measurement is performed by tuning a tapping frequency within a range from 200 Hz to 400 Hz. The cantilever may be, for example, “SPM-probe NCH normal-type PointProbe L (cantilever length)=125 um” manufactured by NanoWorld AG. Next, the AFM image is divided into 512×512 (=262,144) measurement points. The heights Z(i) (i: measurement point number, i=1 to 262,144) are measured at each of the measurement points, and the heights Z(i) of the measurement points are simply averaged (arithmetically averaged) to obtain an average height (average plane)Zave (=(Z(1)+Z(2)+ . . . +Z(262,144))/262,144). Subsequently, a standard deviation Z″(i)=|Z(i)−Zave|) of each of the measuring points from the average center line is obtained, and the arithmetic mean roughness Ra [nm] (=(Z″(1)+Z″(2)+ . . . +Z″(262,144))/262,144) is calculated. In this case, data processed through image processing, such as a filtering processing performed by Flatten order 2 and planefit order 3 XY, is used.

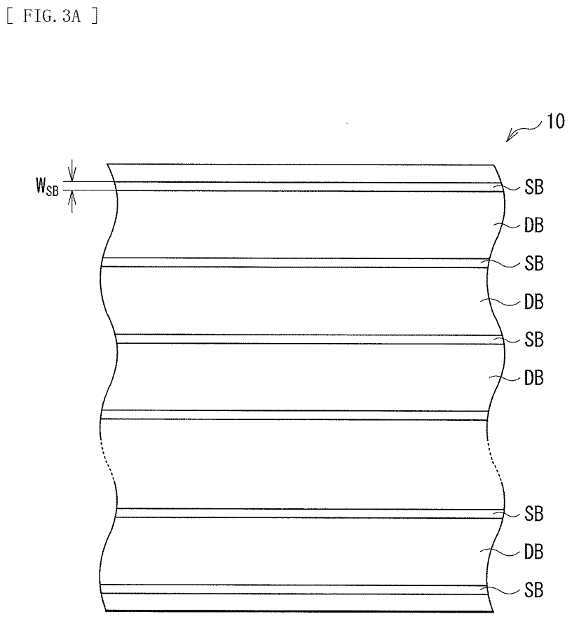

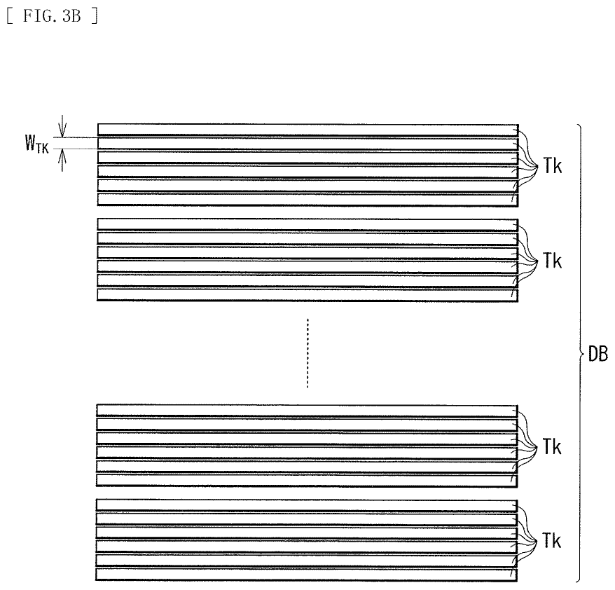

The magnetic layer 13 preferably includes a plurality of servo bands SB and a plurality of data bands DB in advance, for example, as illustrated in FIG. 3A. FIG. 3A is an explanatory outline view of a layout of the data bands DB and the servo bands SB in the magnetic recording medium 10, and illustrates an in-plane layout orthogonal to a stacking direction in the magnetic recording medium 10 having a stacked structure. As illustrated in FIG. 3A, the plurality of servo bands SB are provided at an equal interval in a width direction of the magnetic recording medium 10. The width direction of the magnetic recording medium 10 is a direction orthogonal to both of the longitudinal direction of the magnetic recording medium 10 and the stacking direction of the magnetic recording medium 10. The data band DB is provided between the servo bands SB adjacent to each other in the width direction. In the servo band SB, a servo signal for controlling the tracking of the magnetic head is written in advance. User data is recorded in the data band DB.

The upper limit value of a ratio R_{S} of a total area S_{SB} of the servo bands SB to an area S of the surface 13S of the magnetic layer 13 (=S_{SB}/S)×100) is preferably 4.0% or less, more preferably 3.0% or less, and still more preferably 2.0% or less, from the viewpoint of ensuring a high recording capacity. Meanwhile, the lower limit value of the ratio R_{S} of the total area S_{SB} of the servo bands SB to the area S of the surface of the magnetic layer 13 is preferably 0.8% or more from the viewpoint of ensuring five or more servo tracks.

The ratio R_{S} of the total area S_{SB} of the servo bands SB to the area S of the surface of the magnetic layer 13 is able to be measured, for example, by developing the magnetic recording medium 10 using Ferricolloid developer (manufactured by Sigma Hi-Chemical Inc., Sigmarker Q), and then observing the developed magnetic recording medium 10 with an optical microscope. From the image observed by the optical microscope, a servo band width W_{SB} and the number of the servo bands are measured. Next, the ratio R_{S} is determined from the following expression.

Ratio R_{S}[%]=(((servo band width W_{SB})×(number of servo bands))/(width of magnetic recording medium 10))×100

The number of the servo bands SB is preferably five or more, and more preferably 5+4n (where n is a positive integer) or more. When the number of the servo bands SB is five or more, it is possible to suppress an influence of the dimensional change of the magnetic recording medium 10 in the width direction on the servo signal, and to ensure stable recording and reproduction characteristics with fewer off-tracks.

The upper limit value of the servo band width W_{SB} is preferably 95 μm or less, more preferably 60 μm or less, and still more preferably 30 μm or less, from the viewpoint of ensuring a high recording capacity. The lower limit value of the servo band width W_{SB} is preferably 10 μm or more from the viewpoint of manufacturing the recording head. The width of the servo band width W_{SB} is determined as follows. First, the magnetic recording medium 10 is developed using Ferricolloid developer (manufactured by Sigma Hi-Chemical Inc., Sigmarker Q). Next, the width of the servo band width W_{SB} is able to be measured by observing the developed magnetic recording medium 10 with an optical microscope.

As illustrated in FIG. 3B, the magnetic layer 13 is configured to enable a plurality of data tracks Tk to be formed in the data band DB. FIG. 3B is an enlarged explanatory outline view of the data band DB illustrated in FIG. 3A. In this case, the upper limit value of a data track width W_{Tk} is preferably 2.0 μm or less, more preferably 1.5 μm or less, and still more preferably 1.0 μm or less, from the viewpoint of ensuring a high recording capacity. The lower limit value of the data track width W_{Tk} is preferably 0.02 μm or more from the viewpoint of magnetic particle size.

From the viewpoint of ensuring a high recording capacity, the magnetic layer 13 is configured to be able to record data to allow the minimum value of a distance L between magnetization reversals to be preferably 48 nm or less, more preferably 44 nm or less, and still more preferably 40 nm or less. The lower limit value of the minimum value of the distance L between the magnetization reversals is preferably 20 nm or more from the viewpoint of the magnetic particle size.

The upper limit value of the average thickness of the magnetic layer 13 is preferably 90 nm or less, particularly preferably 80 nm or less, more preferably 70 nm or less, and still more preferably 50 nm or less. In a case where the upper limit value of the average thickness of the magnetic layer 13 is 90 nm or less and where a ring-type head is used as the recording head, it is possible to record magnetizations uniformly in the thickness direction of the magnetic layer 13, and thus to improve the electromagnetic conversion characteristics.

The lower limit value of the average thickness of the magnetic layer 13 is preferably 35 nm or more. In a case where the upper limit value of the average thickness of the magnetic layer 13 is 35 nm or more and where an MR-type head is used as a reproducing head, it is possible to secure the output, and thus to improve the electromagnetic conversion characteristics.

The average thickness of the magnetic layer 13 is determined as follows.

First, the magnetic recording medium 10 is processed through, for example, a FIB (focused ion beam) method into a thin piece. In a case where the FIB method is used, the formation of the carbon films and the tungsten thin film serving as the protective film is performed as a pretreatment for observing a cross-sectional TEM image described later. The carbon films are formed on a surface of the magnetic recording medium 10 on the side of the magnetic layer and a surface of the magnetic recording medium 10 on a side of the back layer, by a deposition method. The tungsten thin film is then further formed on the surface on the side of the magnetic layer by a deposition method or a sputtering method. The thinning is performed along the length direction (longitudinal direction) of the magnetic recording medium 10. That is, the thinning forms a cross-section parallel to both the longitudinal direction and the thickness direction of the magnetic recording medium 10. The cross-section of the obtained thin sample piece is observed using a transmission electron microscope (TEM) under the following conditions to obtain a TEM image. It is to be noted that magnification and acceleration voltage may be appropriately adjusted depending on the type of the apparatus.
Apparatus: TEM (H9000NAR manufactured by Hitachi, Ltd.)
Acceleration voltage: 300 kV
Magnification: 100,000 times

Next, the obtained TEM image is used to measure the thickness of the magnetic layer 13 at ten points or more along the longitudinal direction of the magnetic recording medium 10. The obtained measurement values are simply averaged (arithmetically averaged) to obtain an average value, which is defined as the average thickness of the magnetic layer 13. It is to be noted that the measurement points are randomly selected on the sample piece.

### (Magnetic Powder)

The magnetic powders contain, for example, nanoparticle powders containing ε-iron oxide (hereinafter referred to as “ε-iron oxide particle”). Even when the ε-iron oxide particles are fine particles, it is possible to obtain a high coercivity. It is preferable that the ε-iron oxide contained in the ε-iron oxide particle is preferentially crystallographically oriented in the thickness direction (vertical direction) of the magnetic recording medium 10.

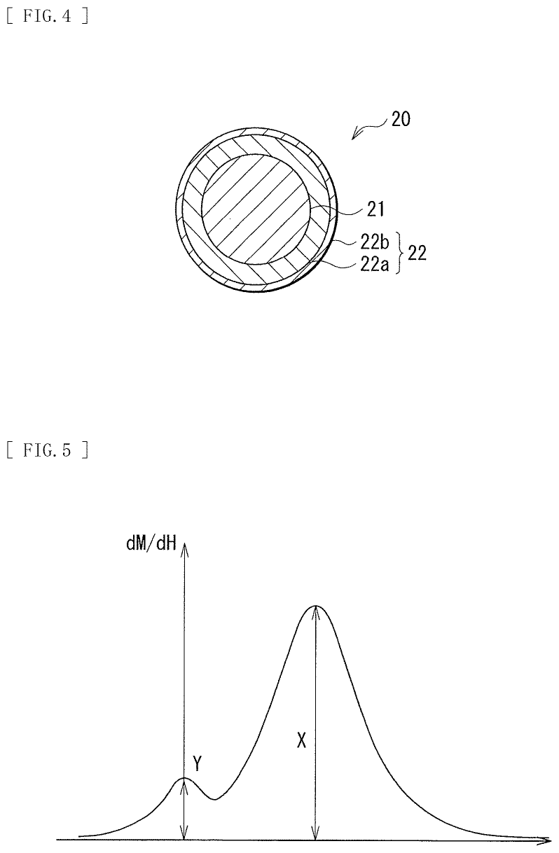

FIG. 4 is a schematic cross-sectional view of an example of a cross-sectional structure of an ε-iron oxide particle 20 contained in the magnetic layer 13. As illustrated in FIG. 4, the ε-iron oxide particle 20 has a spherical or substantially spherical shape, or a cubic or substantially cubic shape. Because the ε-iron oxide particle 20 has a shape as described above, in a case where the ε-iron oxide particles 20 are used as magnetic particles, it is possible to reduce the contact area between the particles in the thickness direction of the magnetic recording medium 10, and thus to suppress aggregation of the particles, as compared with the case of using hexagonal plate-shaped barium ferrite particles as the magnetic particles. Therefore, it is possible to obtain enhanced dispersibility of the magnetic powders and a favorable SNR (Signal-to-Noise Ratio).

The ε-iron oxide particle 20 has a core-shell structure, for example. Specifically, as illustrated in FIG. 4, the ε-iron oxide particle 20 includes a core part 21 and a shell part 22 having a two-layer structure provided around the core part 21. The shell part 22 of the two-layer structure includes a first shell part 22a provided on the core part 21, and a second shell part 22b provided on the first shell part 22a.

The core part 21 of the ε-iron oxide particle 20 contains ε-iron oxide. The ε-iron oxide contained in the core part 21 includes preferably ε-Fe₂O₃ crystals as a main phase, more preferably a single phase of ε-Fe₂O₃.

The first shell part 22a covers at least a portion of the periphery of the core part 21. Specifically, the first shell part 22a may partially cover the periphery of the core part 21 or may cover the entire periphery of the core part 21. From the viewpoint of ensuring sufficient exchange coupling between the core part 21 and the first shell part 22a and improving magnetic characteristics, it is preferable to cover the entire surface of the core part 21.

The first shell part 22a is a so-called soft magnetic layer, and contains, for example, a soft magnetic material such as α-Fe, Ni—Fe alloy or Fe—Si—Al alloy. The α-Fe may be obtained by reducing the ε-iron oxide contained in the core part 21.

The second shell part 22b is an oxide film serving as an antioxidant layer. The second shell part 22b contains α-iron oxide, aluminum oxide, or silicon oxide. The α-iron oxide includes, for example, at least one iron oxide of Fe₃O₄, Fe₂O₃, or FeO. In a case where the first shell part 22a contains α-Fe (soft magnetic material), the α-iron oxide may be obtained by oxidizing the α-Fe contained in the first shell part 22a.

The ε-iron oxide particles 20 including the first shell part 22a as described above makes it possible to adjust coercivity He of the entire ε-iron oxide particle (core shell particle) 20 to the coercivity He suitable for recording while maintaining the coercivity He of the core part 21 alone at a large value in order to ensure thermal stability. In addition, the ε-iron oxide particle 20 including the second shell part 22b as described above makes it possible to suppress deterioration of the characteristics of the ε-iron oxide particle 20 due to rust or the like generating on the particle surface as a result of exposure of the ε-iron oxide particles 20 to air during or before the manufacturing step of the magnetic recording medium 10. Therefore, it is possible to suppress the characteristic deterioration of the magnetic recording medium 10 by covering the first shell part 22a with the second shell part 22b.

The average particle size (average maximum particle size) of the magnetic powders is preferably 25 nm or less, more preferably 8 nm or more and 22 nm or less, and still more preferably 12 nm or more and 22 nm or less. In the magnetic recording medium 10, a region having a size of half the recording wavelength corresponds to an actual magnetization region. Therefore, it is possible to obtain a favorable S/N by setting the average particle size of the magnetic powders to half or less of the shortest recording wavelength. Therefore, when the average particle size of the magnetic powders is 22 nm or less, it is possible to obtain favorable electromagnetic conversion characteristics (e.g., SNR) of the magnetic recording medium 10 having a high recording density (e.g., the magnetic recording medium 10 configured to be able to record signals at the shortest recording wavelength of 50 nm or less). Meanwhile, when the average particle size of the magnetic powders is 8 nm or more, it is possible to further improve the dispersibility of the magnetic powders, and thus to obtain more excellent electromagnetic conversion characteristics (e.g., SNR).

The average aspect ratio of the magnetic powders is preferably 1 or more and 3.0 or less, more preferably 1 or more and 2.8 or less, and still more preferably 1 or more and 1.8 or less. When the average aspect ratio of the magnetic powders is within the range from 1 to 3.0 inclusive, it is possible to suppress aggregation of the magnetic powders and reduce resistance applied to the magnetic powders when the magnetic powders are perpendicularly oriented in the step of forming the magnetic layer 13. Therefore, it is possible to improve the vertical orientation of the magnetic powders.

The average particle size and the average aspect ratio of the magnetic powders as described above are determined as follows. First, the magnetic recording medium 10 to be measured is processed through, for example, the FIB (Focused Ion Beam) method into a thin piece. The thinning is performed along the length direction (longitudinal direction) of the magnetic tape. That is, the thinning forms a cross-section parallel to both the longitudinal direction and the thickness direction of the magnetic recording medium 10. The cross-section of the obtained thin sample piece is observed using a transmission electron microscope (H-9500 manufactured by Hitachi High-Technologies) at an acceleration voltage of 200 kV and total magnification of 500,000 times, to allow the magnetic layer 13 to be entirely included in the thickness direction of the magnetic layer 13. A TEM photograph is then captured. Next, 50 particles are randomly selected from the captured TEM photograph, and a major axis length DL and a minor axis length DS of each particle are measured. Here, the major axis length DL refers to the maximum distance between any two parallel lines drawn from any angles so as to contact the contour of each particle (so-called maximum Feret diameter). Meanwhile, the minor axis length DS refers to the maximum length of the particle in the direction orthogonal to the major axis length DL of the particle.

Subsequently, the major axis lengths DL of the 50 measured particles are simply averaged (arithmetically averaged) to determine an average major axis length DLave. The average major axis length DLave determined in this manner is defined as the average particle size of the magnetic powders. The minor axis lengths DS of the 50 measured particles are simply averaged (arithmetically averaged) to determine an average minor axis length DSave. Thereafter, an average aspect ratio (DLave/DSave) of the powders is determined from the average major axis length DLave and the average minor axis length DSave.

The average particle volume of the magnetic powders is preferably 5500 nm³ or less, more preferably 270 nm³ or more and 5500 nm³ or less, and still more preferably 900 nm³ or more and 5500 nm³ or less. When the average particle volume of the magnetic powders is 5500 nm³ or less, it is possible to obtain effects similar to those of the case where the average particle size of the magnetic powders is set to 22 nm or less. Meanwhile, when the average particle volume of the magnetic powders is 270 nm³ or more, it is possible to obtain effects similar to those of the case where the average particle size of the magnetic powders is set to 8 nm or more.

When the ε-iron oxide particle 20 has a spherical or substantially spherical shape, the average particle volume of the magnetic powders is determined as follows. First, the average major axis length DLave is determined in the same manner as the above-described calculation methods of the average particle sizes of the magnetic powders. Next, an average particle volume V of the magnetic powders is determined using the following expression.

V=(π/6)×(DLave)³

### (Binder)

It is preferable to use, as the binder, a resin having a structure in which a crosslinking reaction is imparted to a polyurethane-based resin, a vinyl chloride-based resin, or the like. However, the binder is not limited thereto, and other resins may be appropriately blended depending on required physical properties and the like of the magnetic recording medium 10. The resin to be blended is not particularly limited as long as being a resin commonly used in the magnetic recording medium 10 of a coating type.

Examples of the binder include polyvinyl chloride, polyvinyl acetate, vinyl chloride-vinyl acetate copolymer, vinyl chloride-vinylidene chloride copolymer, vinyl chloride-acrylonitrile copolymer, acrylic acid ester-acrylonitrile copolymer, acrylic acid ester-vinyl chloride-vinylidene chloride copolymer, vinyl chloride-acrylonitrile copolymer, acrylic acid ester-acrylonitrile copolymer, acrylic acid ester-vinylidene chloride copolymer, methacrylic acid ester-vinylidene chloride copolymer, methacrylic acid ester-vinyl chloride copolymer, methacrylic acid ester-ethylene copolymer, polyvinyl fluoride, vinylidene chloride-acrylonitrile copolymer, acrylonitrile-butadiene copolymer, polyamide resin, polyvinyl butyral, cellulose derivatives (cellulose acetate butyrate, cellulose diacetate, cellulose triacetate, cellulose propionate, and nitrocellulose), styrene butadiene copolymer, polyester resin, amino resin, synthetic rubber, and the like.

In addition, examples of the thermosetting resin or the reactive resin include phenolic resin, epoxy resin, urea resin, melamine resin, alkyd resin, silicone resin, polyamine resin, urea formaldehyde resin, and the like.

In addition, a polar functional group, such as —SO₃M, —OSO₃M, —COOM, or P═O(OM)₂ may be introduced into each of the binders described above for the purpose of improving the dispersibility of the magnetic powders. Here, M in the above chemical formulae is a hydrogen atom or an alkali metal, such as lithium, potassium, or sodium.

Further, examples of the polar functional group include those of the side chain type having a terminal group of —NR1R2 or —NR1R2R3⁺X⁻, and those of the main chain type of >NR1R2⁺X⁻. Here, R1, R2, and R3 in the above formulae are hydrogen atoms or hydrocarbon groups, and X⁻ is a halogen element ion, such as fluorine, chlorine, bromine, or iodine, or an inorganic or organic ion. Further, another examples of the polar functional group include —OH, —SH, —CN, epoxy groups, and the like.

### (Lubricant)

The lubricant contained in the magnetic layer 13 contains, for example, fatty acid and fatty acid ester. It is preferable that the fatty acid contained in the lubricant include at least one of a compound represented by the following general formula <1> or a compound represented by the following general formula <2>, for example. In addition, it is preferable that the fatty acid ester contained in the lubricant include at least one of a compound represented by the following general formula <3> or a compound represented by the following general formula <4>. It is possible to suppress an increase in dynamic friction coefficient due to repetitive recording or reproducing on the magnetic recording medium 10 by the lubricant including two compounds of the compound represented by the general formula <1> and the compound represented by the general formula <3>; the lubricant including two compounds of the compound represented by the general formula <2> and the compound represented by the general formula <3>; the lubricant including two compounds of a compound represented by the general formula <1> and the compound represented by the general formula <4>; the lubricant including two compounds of a compound represented by the general formula <2> and a compound represented by the general formula <4>; the lubricant including three compounds of the compound represented by the general formula <1>, the compound represented by the general formula <2>, and the compound represented by the general formula <3>; the lubricant including three compounds of the compound represented by general formula <1>, the compound represented by general formula <2>, and the compound represented by the general formula <4>; the lubricant including three compounds of the compound represented by the general formula <1>, the compound represented by the general formula <3>, and the compound represented by the general formula <4>; the lubricant including three compounds of the compound represented by the general formula <2>, the compound represented by the general formula <3>, and the compound represented by the general formula <4>; or the lubricant including four compounds of the compound represented by the general formula <1>, the compound represented by the general formula <2>, the compound represented by the general formula <3>, and the compound represented by the general formula <4>. As a result, it is possible to further improve the traveling performance of the magnetic recording medium 10.

CH₃(CH₂)ₖCOOH <1>
(Note that, in the general formula <1>, k is an integer selected from the range of 14 to 22 inclusive, and more preferably the range of 14 to 18 inclusive.)

CH₃(CH₂)ₙCH=CH(CH₂)ₘCOOH <2>
(Note that, in the general formula <2>, the sum of n and m is an integer selected from the range of 12 to 20 inclusive, and more preferably the range of 14 to 18 inclusive.)

CH₃(CH₂)ₚCOO(CH₂)_{q}CH₃ <3>
(Note that, in the general formula <3>, p is an integer selected from the range of 14 to 22 inclusive, more preferably the range of 14 to 18 inclusive, and q is an integer selected from the range of 2 to 5 inclusive, more preferably the range of 2 to 4 inclusive.)

CH₃(CH₂)ₚCOO—(CH₂)_{q}CH(CH₃)₂ <4>
(Note that, in the general formula <4>, p is an integer selected from the range of 14 to 22 inclusive, and q is an integer selected from the range of 1 to 3 inclusive.)

### (Additive)

The magnetic layer 13 may further contain aluminum oxide (α, β, or γ alumina), chromium oxide, silicon oxide, diamond, garnet, emery, boron nitride, titanium carbide, silicon carbide, titanium carbide, titanium oxide (rutile or anatase-type titanium oxide), or the like as non-magnetic reinforcing particles.

### (Underlayer 12)

The underlayer 12 is a non-magnetic layer containing non-magnetic powders and a binder. The underlayer 12 may further include at least one additive of, for example, a lubricant, conductive particles, a curing agent, or a rust inhibitor, as needed. In addition, the underlayer 12 may have a multilayer structure in which a plurality of layers are stacked. The average thickness of the underlayer 12 is preferably 0.5 μm or more and 0.9 μm or less, and more preferably 0.5 μm or more and 0.7 μm or less. The average thickness of the underlayer 12 is as thin as 0.9 μm or less, which effectively decreases Young's modulus of the entire magnetic recording medium 10, as compared with the case where the thickness of the substrate 11 is reduced. This facilitates tension control over the magnetic recording medium 10. In addition, the average thickness of the underlayer 12 is set to 0.5 μm or more, thereby ensuring adhesion strength between the substrate 11 and the underlayer 12. Furthermore, it is possible to suppress variations in the thickness of the underlayer 12 and thus to prevent an increase in roughness of the surface 13S of the magnetic layer 13.

The average thickness of the underlayer 12 is determined, for example, as follows. First, the magnetic recording medium 10 having a width of ½ inches is prepared, and cut into a length of 250 mm to produce a sample. Subsequently, the underlayer 12 and the magnetic layer 13 are removed from the substrate 11 of the sample of the magnetic recording medium 10. Next, the measuring apparatus, Laser Hologauge (LGH-110C) manufactured by Mitsutoyo Corporation, is used to measure the thickness of a stacked body of the underlayer 12 and the magnetic layer 13 removed from the substrate 11 at five points or more. Thereafter, these measurement values are simply averaged (arithmetically averaged) to calculate an average thickness of the stacked body of the underlayer 12 and the magnetic layer 13. It is to be noted that the measurement points are randomly selected on the sample. Finally, an average thickness of the underlayer 12 is determined by subtracting the average thickness of the magnetic layer 13 measured using the TEM as described above from the average thickness of the stacked body.

The underlayer 12 preferably has multiple pores. The lubricant being stored in these multiple pores makes it possible to further suppress a decrease in the amount of the lubricant supplied to between the surface 13S of the magnetic layer 13 and the magnetic head even after repetitive recording or reproducing is performed (i.e., even after the magnetic head travels repeatedly while being in contact with the surface of the magnetic recording medium 10). Therefore, it is possible to further suppress an increase in the dynamic friction coefficient.

### (Non-Magnetic Powder of Underlayer 12)

The non-magnetic powders include, for example, at least one of inorganic particle powders or organic particle powders. In addition, the non-magnetic powders may include carbon powders, such as carbon black. One kind of non-magnetic powders may be used alone, or two or more kinds of non-magnetic powders may be used in combination. Examples of the inorganic particles include metals, metal oxides, metal carbonates, metal sulfates, metal nitrides, metal carbides or metal sulfides, or the like. The non-magnetic powders have various shapes including, but not limited thereto, needle-like, spherical, cubic, or plate-like shapes, for example.

### (Binder for Underlayer 12)

The binder for the underlayer 12 is similar to that in the magnetic layer 13 described above.

### (Back Layer 14)

The back layer 14 includes, for example, a binder and non-magnetic powders. The back layer 14 may further include at least one additive of a lubricant, a curing agent, an antistatic agent, or the like, as needed. The binder and the non-magnetic powders in the back layer 14 are similar to the binder and the non-magnetic powders in the underlayer 12 described above.

The average particle size of the non-magnetic powders in the back layer 14 is preferably 10 nm or more and 150 nm or less, more preferably 15 nm or more and 110 nm or less. The average particle size of the non-magnetic powders in the back layer 14 is determined in the same manner as for the average particle size of the magnetic powders in the magnetic layer 13 described above. The non-magnetic powders may include one having a particle size distribution of two or more.

The upper limit value of the average thickness of the back layer 14 is preferably 0.6 μm or less, and particularly preferably 0.5 μm or less. When the upper limit value of the average thickness of the back layer 14 is 0.6 μm or less, it is possible to keep the thicknesses of the underlayer 12 and the substrate 11 thick even in a case where the average thickness of the magnetic recording medium 10 is 5.8 μm or less, and thus to maintain traveling stability of the magnetic recording medium 10 in the recording/reproducing apparatus. The lower limit value of the average thickness of the back layer 14 is, for example, but not particularly limited to, 0.2 μm or more, and particularly preferably 0.3 μm or more.

The average thickness of the back layer 14 is determined as follows. First, the magnetic recording medium 10 having a width of ½ inches is prepared, and cut into a length of 250 mm to produce a sample. Next, the measuring apparatus, Laser Hologauge (LGH-110C) manufactured by Mitsutoyo Corporation, is used to measure the thickness of the sample of the magnetic recording medium 10 at five points or more. Thereafter, these measurement values are simply averaged (arithmetically averaged) to calculate an average thickness t_{T} [μm] of the magnetic recording medium 10. It is to be noted that the measurement points are randomly selected on the sample. Subsequently, the back layer 14 is removed from the sample of the magnetic recording medium 10 with a solvent, such as MEK (methyl ethyl ketone) or dilute hydrochloric acid. Thereafter, the Laser Hologauge is used again to measure the thickness of the sample of the magnetic recording medium 10 from which the back layer 14 has been removed, at five points or more. These measurement values are simply averaged (arithmetically averaged) to calculate an average thickness t_{B}[μm] of the magnetic recording medium 10 from which the back layer 14 has been removed. It is to be noted that the measurement positions are randomly selected on the sample. Finally, an average thickness t_{b} [μm] of the back layer 14 is determined by the following expression. t_{b}[μm]=t_{T}[μm]−t_{B}[μm]

### (Average Thickness of Magnetic Recording Medium 10)

As described earlier, the upper limit value of the average thickness (average total thickness) of the magnetic recording medium 10 is preferably 5.8 μm or less, and more preferably 5.3 μm or less. When the average thickness of the magnetic recording medium 10 is 5.8 μm or less, it is possible to increase the recordable recording capacity of one magnetic recording cartridge 1, as compared with a common magnetic recording medium. In addition, the lower limit value of the average thickness of the magnetic recording medium 10 is preferably 4.0 μm or more, for example. When the average thickness of the magnetic recording medium 10 is 4.0 μm or more, it is possible to effectively suppress deformation of the magnetic recording medium 10.

The average thickness t_{T} of the magnetic recording medium 10 is determined as follows. First, the magnetic recording medium 10 having a width of L/2 inches is prepared, and cut into a length of 250 mm to produce a sample. Next, the measuring apparatus, Laser Hologauge (LGH-110C) manufactured by Mitsutoyo Corporation, is used to measure the thickness of the sample at five points or more. Thereafter, these measurement values are simply averaged (arithmetically averaged) to calculate an average thickness t_{T} [μm]. It is to be noted that the measurement points are randomly selected on the sample.

### (Coercivity Hc)

The upper limit value of the coercivity Hc of the magnetic recording medium 10 in the longitudinal direction is preferably 2000 Oe or less, more preferably 1900 Oe or less, and still more preferably 1800 Oe or less. When coercivity Hc2 in the longitudinal direction is 2000 Oe or less, a high-sensitivity magnetization reaction is caused by a magnetic field in the perpendicular direction from the recording head, thus allowing for formation of a favorable recording pattern.

The lower limit value of the coercivity He measured in the longitudinal direction of the magnetic recording medium 10 is preferably 1000 Oe or more. When the lower limit value of the coercivity He in the longitudinal direction is 1000 Oe or more, it is possible to suppress demagnetization due to a leakage flux from the recording head.

The above-described coercivity He is determined as follows. Three sheets of the magnetic recording media 10 are overlapped on each other by bonding with double-sided tapes, and then punched out by a 6.39 mm-diameter punch to prepare measurement samples. At this time, marking is performed with any ink having no magnetism to allow the longitudinal direction of the magnetic recording medium to be recognizable. Thereafter, a vibrating sample magnetometer (VSM) is used to measure M-H loop of the measuring samples (entire magnetic recording medium 10) corresponding to the longitudinal direction of the magnetic recording medium 10 (traveling direction of the magnetic recording medium 10). Next, acetone, ethanol, or the like is used to wipe off the coating film (underlayer 12, magnetic layer 13, and back layer 14, etc.) to leave only the substrate 11. Then, three sheets of the obtained substrates 11 are overlapped on each other by bonding with double-sided tapes, and then punched out by a 6.39 mm-diameter punch to produce background-correction samples (hereinafter, simply referred to as correction samples). Thereafter, the VSM is used to measure the M-H loop of the correction samples (substrate 11) corresponding to the longitudinal direction of the substrate 11 (traveling direction of the magnetic recording medium 10).

For example, a high sensitivity vibrating sample magnetometer “VSM-P7-15” manufactured by Toei Industry Co., Ltd. is used to measure the M-H loop of the measurement samples (entire magnetic recording medium 10) and the M-H loop of the correction samples (substrate 11). Measurement conditions are as follows: measurement mode: full loop, maximum magnetic field: 15 kOe, magnetic field step: 40 bits, Time constant of Locking amp: 0.3 sec, Waiting time: 1 sec, and MH averaging number: 20.

After the two M-H loops are obtained, the M-H loop of the correction samples (substrate 11) is subtracted from the M-H loop of the measurement samples (entire magnetic recording medium 10) to perform background correction, and an M-H loop after the background correction is thereby obtained. Measurement and analysis programs attached to the “VSMP7-15” are used for calculation in the background correction.

The coercivity He is determined from the obtained M-H loop after the background correction. It is to be noted that the measurement and analysis programs attached to the “VSM-P7-15” are used for this calculation. It is to be noted that the measurements of the M-H loops described above are both performed at 25° C. In addition, “demagnetizing field correction” is not performed when the M-H loop is measured in the longitudinal direction of the magnetic recording medium 10.

### (Squareness Ratio)

A squareness ratio S1 in the perpendicular direction (thickness direction) of the magnetic recording medium 10 is, for example, 65% or more, preferably 67% or more, more preferably 70% or more, still more preferably 75% or more, and particularly preferably 80% or more. When the squareness ratio S1 is 65% or more, the vertical orientation of the magnetic powders becomes sufficiently high. Therefore, it is possible to obtain a more excellent SNR.

The squareness ratio S1 is determined as follows. Three sheets of the magnetic recording media 10 are overlapped on each other by bonding with double-sided tapes, and then punched out by a 6.39 mm-diameter punch to prepare measurement samples. At this time, marking is performed with any ink having no magnetism to allow the longitudinal direction (traveling direction) of the magnetic recording medium to be recognizable. Thereafter, a vibrating sample magnetometer (VSM) is used to measure M-H loop of the measuring samples (entire magnetic recording medium 10) corresponding to the perpendicular direction of the magnetic recording medium 10 (thickness direction of the magnetic recording medium 10). Next, acetone, ethanol, or the like is used to wipe off the coating film (underlayer 12, magnetic layer 13, and back layer 14, etc.) to leave only the substrate 11. Then, three sheets of the obtained substrates 11 are overlapped on each other by bonding with double-sided tapes, and then punched out by a 6.39 mm-diameter punch to produce background-correction samples (hereinafter, simply referred to as correction samples). Thereafter, the VSM is used to measure the M-H loop of the correction samples (substrate 11) corresponding to the perpendicular direction of the substrate 11 (thickness direction of the magnetic recording medium 10).

For example, a high sensitivity vibrating sample magnetometer “VSM-P7-15” manufactured by Toei Industry Co., Ltd. is used to measure the M-H loop of the measurement samples (entire magnetic recording medium 10) and the M-H loop of the correction samples (substrate 11). Measurement conditions are as follows: measurement mode: full loop, maximum magnetic field: 15 kOe, magnetic field step: 40 bits, Time constant of Locking amp: 0.3 sec, Waiting time: 1 sec, and MH averaging number: 20.

After the two M-H loops are obtained, the M-H loop of the correction samples (substrate 11) is subtracted from the M-H loop of the measurement samples (entire magnetic recording medium 10) to perform background correction, and an M-H loop after the background correction is thereby obtained. Measurement and analysis programs attached to the “VSMP7-15” are used for calculation in the background correction.

Saturation magnetization Ms (emu) and residual magnetization Mr (emu) of the obtained M-H loop after the background correction are substituted in the following expression to calculate the squareness ratio S1 (%).

Squareness Ratio S1(%)=(Mr/Ms)×100

It is to be noted that the measurement of the M-H loops described above are both performed at 25° C. In addition, “demagnetizing field correction” is not performed when the M-H loop is measured in the perpendicular direction of the magnetic recording medium 10.

A squareness ratio S2 in the longitudinal direction (traveling direction) of the magnetic recording medium 10 is preferably 35% or less, more preferably 30% or less, still more preferably 25% or less, particularly preferably 20% or less, and most preferably 15% or less. When the squareness ratio S2 is 35% or less, the vertical orientation of the magnetic powders becomes sufficiently high. Therefore, it is possible to obtain a more excellent SNR.

The squareness ratio S2 is determined in the same manner as for the squareness ratio S1 except that the M-H loops are measured in the longitudinal direction (traveling direction) of the magnetic recording medium 10 and the substrate 11.

### (SFD)

In an SFD (Switching Field Distribution) curve of the magnetic recording medium 10, the peak ratio X/Y between a main peak height X and a sub-peak height Y near zero magnetic field is preferably 3.0 or more, more preferably 5.0 or more, still more preferably 7.0 or more, particularly preferably 10.0 or more, and most preferably 20.0 or more (see FIG. 5). FIG. 5 is a graph illustrating an example of an SFD curve of the magnetic recording medium 10 illustrated in FIG. 2. When the peak ratio X/Y is 3.0 or more, it is possible to suppress a large amount of low coercivity components (e.g., soft magnetic particles or superparamagnetic particles), peculiar to ε-iron oxide, being contained in the magnetic powders, other than the ε-iron oxide particles 20 contributing to actual recording. Therefore, it is possible to suppress the deterioration of magnetization signals recorded in adjacent tracks due to leakage of a magnetic field from the recording head, and thus to obtain a more excellent SNR. The upper limit value of the peak ratio X/Y is, for example, but not particularly limited to, 100 or less.

The peak ratio X/Y is determined as follows. First, the M-H loop after the background correction is obtained in the same manner as in the method of measuring the coercivity He described above. Next, an SFD curve is calculated from the obtained M-H loop. For the calculation of the SFD curve, a program attached to the measuring apparatus may be used, or other programs may be used. The peak ratio X/Y is calculated, where “Y” is the absolute value of the point at which the calculated SFD curve crosses a Y-axis (dM/dH), and “X” is the height of the main peak observed in the vicinity of the coercivity He in the M-H loop. It is to be noted that the measurement of the M-H loop is performed at 25° C. in the same manner as in the method of measuring the coercivity He described above. In addition, “demagnetizing field correction” is not performed when the M-H loop is measured in the thickness direction (perpendicular direction) of the magnetic recording medium 10. Further, a plurality of samples to be measured may be overlapped on each other for the measurement of the M-H loop depending on the sensitivity of the VSM to be used.

### (Activation Volume Vact)

The activation volume Vact is preferably 8000 nm³ or less, more preferably 6000 nm³ or less, still more preferably 5000 nm³ or less, particularly preferably 4000 nm³ or less, and most preferably 3000 nm³ or less. When the activation volume Vact is 8000 nm³ or less, the dispersion state of the magnetic powders becomes favorable. Therefore, it is possible to make a bit inversion region steep and thus to suppress deterioration of the magnetization signals recorded in adjacent tracks due to leakage of a magnetic field from the recording head. Accordingly, it is possible to obtain a more excellent SNR.

The activation volume Vact described above is determined by the following expression derived by Street & Woolley.

Vact(nm³)=kB−T×Xirr/(μ0×Ms×S)
(where kB denotes Boltzmann's constant (1.38×10⁻²³ J/K), T denotes temperature (K), Xirr denotes irreversible magnetic susceptibility, μ0 denotes magnetic permeability in vacuum, S denotes magnetic viscosity coefficient, and Ms denotes saturation magnetization (emu/cm³)).

The irreversible magnetic susceptibility Xirr, the saturation magnetization Ms, and the magnetic viscosity coefficient S to be substituted in the above expression are determined by using the VSM as follows. Three sheets of the magnetic recording media 10 are overlapped on each other by bonding with double-sided tapes, and then punched out by a 6.39 mm-diameter punch to prepare measurement samples to be used for the VSM. At this time, marking is performed with any ink having no magnetism to allow the longitudinal direction (traveling direction) of the magnetic recording medium 10 to be recognizable. It is to be noted that the measurement by the VSM is performed in the thickness direction (perpendicular direction) of the magnetic recording medium 10. In addition, the measurement on the measurement samples cut out from the elongated magnetic recording medium 10 is performed using the VSM, at 25° C. In addition, “demagnetizing field correction” is not performed when the M-H loop is measured in the thickness direction (perpendicular direction) of the magnetic recording medium 10. Further, the high sensitivity vibrating sample magnetometer “VSM-P7-15” manufactured by Toei Industry Co., Ltd. is used to measure the M-H loop of the measurement samples (entire of the magnetic recording medium 10) and the M-H loop of the correction samples (substrate 11). Measurement conditions are as follows: measurement mode: full loop, maximum magnetic field: 15 kOe, magnetic field step: 40 bits, Time constant of Locking amp: 0.3 sec, Waiting time: 1 sec, and MH averaging number: 20.

### (Irreversible Magnetic Susceptibility Xirr)

The irreversible magnetic susceptibility Xirr is defined as a slope in the vicinity of a residual coercivity Hr of the slope of the residual magnetization curve (DCD curve). First, a magnetic field of −1193 kA/m (15 kOe) is applied to the entire magnetic recording medium 10, and the magnetic field is returned to zero to be a residual magnetization state. Thereafter, a magnetic field of about 15.9 kA/m (200 Oe) is applied in the opposite direction, and the magnetic field is returned to zero again to measure the residual magnetic amount. Thereafter, similarly, the measurement in which a magnetic field greater than the previously applied magnetic field by 15.9 kA/m is applied and returned to zero is repeatedly performed, and the residual magnetization amount is plotted with respect to the applied magnetic field to measure a DCD curve. From the obtained DCD curve, the point where the magnetization amount becomes zero is determined as the residual coercivity Hr. Further, the DCD curve is differentiated to determine the slope of the DCD curve in each magnetic field. Out of the slope of the DCD curve, the slope in the vicinity of the residual coercivity Hr is Xirr.

### (Saturation Magnetization Ms)

First, the M-H loop after the background correction is obtained in the same manner as in the method of measuring the coercivity He described above. Next, Ms (emu/cm³) is calculated from the value of the saturation magnetization Ms (emu) of the obtained M-H loop and the volume (cm³) of the magnetic layer 13 in each measurement sample. It is to be noted that the volume of the magnetic layer 13 is determined by multiplying the area of the measurement sample by the average thickness of the magnetic layer 13. The method of calculating the average thickness of the magnetic layer 13 necessary for calculating the volume of the magnetic layer 13 is as described above.

### (Magnetic Viscosity Coefficient S)

First, a magnetic field of −1193 kA/m (15 kOe) is applied to the entire magnetic recording medium 10 (measurement samples), and the magnetic field is returned to zero to be a residual magnetization state. Thereafter, a magnetic field equivalent to the value of the residual coercivity Hr obtained from the DCD curve is applied in the opposite direction. The amount of magnetization is continuously measured at regular time intervals for 1000 seconds in a state where the magnetic field is applied. The relationship between the time t and the magnetization amount M(t) obtained in such a manner is used in the following expression to calculate the magnetic viscosity coefficient S.

M(t)=M0+S×ln(t)
(where M(t) denotes the magnetization amount of the time t, M0 denotes an initial magnetization amount, S denotes the magnetic viscosity coefficient, and ln(t) denotes the natural logarithm of the time).

### (Dimensional Change Amount Δw)

A dimensional change amount Δw [ppm/N] of the magnetic recording medium 10 in the width direction with respect to a change in a tension of the magnetic recording medium 10 in the longitudinal direction is preferably 650 ppm/N≤Δw, more preferably 700 ppm/N≤Δw, still more preferably 750 ppm/N≤Δw, and particularly preferably 800 ppm/N≤Δw. When the dimensional change amount Δw is 650 ppm/N<Δw, adjustment of the tension of the magnetic recording medium 10 in the longitudinal direction by a recording/reproducing apparatus 30 described later makes it possible to suppress the change in the width of the magnetic recording medium 10 more effectively. The upper limit value of the dimensional change amount Δw is not particularly limited; however, the following may hold true: for example, Δw≤1700000 ppm/N, preferably Δw≤20000 ppm/N, more preferably Δw≤8000 ppm/N, still more preferably Δw≤5000 ppm/N, Δw≤4000 ppm/N, Δw≤3000 ppm/N, or Δw≤2000 ppm/N.

The dimensional change amount Δw may be set to a desired value depending on selection of the substrate 11. For example, the dimensional change amount Δw may be set to a desired value by selecting at least one of the thickness of the substrate 11 or a material of the substrate 11. In addition, the dimensional change amount Δw may be set to a desired value, for example, by adjusting the stretching intensity in the width direction and the longitudinal direction of the substrate 11. For example, stretching more intensely in the width direction of the substrate 11 further decreases the dimensional change amount Δw; conversely, intensifying the stretching in the longitudinal direction of the substrate 11 increases the dimensional change amount Δw.

The dimensional change amount Δw is determined as follows. First, the magnetic recording medium 10 having a width of ½ inches is prepared, and cut into a length of 250 mm to acquire a sample 10S. Next, a load is applied in the order of 0.2 N, 0.6 N, and 1.0 N in the longitudinal direction of the sample 10S, and the width of the sample 10S is measured at the loads of 0.2 N, 0.6 N, and 1.0 N. Subsequently, the dimensional change amount Δw is determined by the following expression. It is to be noted that the measurement in the case of applying the load of 0.6 N is performed to confirm that there is no abnormality in the measurement (in particular, to confirm that these three measurement results are linear); the measurement result is not used in the following expression

$$△ w [ ppm / N ] = \frac{D ( 0.2 N ) [ mm ] - D ( 1. N ) [ mm ]}{D ( 0.2 N ) [ mm ]} \times \frac{1 , 000 , 000}{( 1. [ N ] ) - ( 0.2 [ N ] )}$$

(Note that, in the expression, D (0.2 N) and D (1.0 N) denote widths of the sample 10S at the time when the respective loads of 0.2 N and 1.0 N are applied in the longitudinal direction of the sample 10S.)

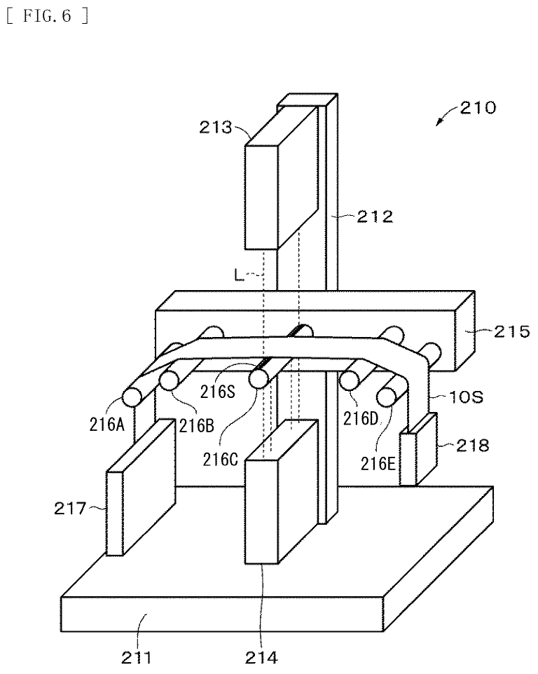

The width of the sample 10S at the time when each of the loads is applied is measured using a measuring apparatus, for example, illustrated in FIG. 6. FIG. 6 is a schematic outline view of an appearance of a measuring apparatus 210 to be used to measure the width of the magnetic recording medium 10. First, description is given of the measuring apparatus 210 with reference to FIG. 6. The measuring apparatus 210 includes a seating 211, a support column 212, a light emitter 213, a light receiver 214, a support plate 215, five support members 216A to 216E, and a fixing part 217.

The seating 211 has a rectangular plate shape. The light receiver 214 is provided in the middle of the seating 211. The support column 212 stands adjacent to the light receiver 214 at a position offset toward one long side from the center of the seating 211. The fixing part 217 is provided on one short side of the seating 211.

The light emitter 213 is supported at the tip portion of the support column 212. The light emitter 213 and the light receiver 214 are opposed to each other. Upon measuring, the sample 10S supported by the support members 216A to 216E is disposed between the light emitter 213 and the light receiver 214 opposed to each other. The light emitter 213 and the light receiver 214 are coupled to an unillustrated PC (personal computer), measure the width of the sample 10S supported by the support members 216A to 216E under the control of the PC, and output measurement results to the PC.

The light emitter 213 and the light receiver 214 incorporate a digital dimension measuring instrument LS-7000 manufactured by Keyence Corporation. The light emitter 213 irradiates the sample 10S with linear light parallel to the width direction of the sample 10S supported by the support members 216A to 216E. The light receiver 214 measures the width of the sample 10S by measuring an amount of light not having been blocked by the sample 10S.

An elongated rectangular support plate 215 is fixed to the support column 212 at a position substantially half the height thereof. The support plate 215 is supported to allow a long side of the support plate 215 to be parallel to a main surface of the seating 211. One main surface of the support plate 215 supports the five support members 216A to 216E. The support member 216A to 216E each have a cylindrical rod shape, and support a back surface of the sample 10S (magnetic recording medium 10). All of the five support members 216A to 216E (in particular, surfaces thereof) are each configured by stainless steel SUS304, and each have a surface roughness Rz (maximum height) of 0.15 μm to 0.3 μm inclusive.

Here, description is given of the arrangement of the five support members 216A to 216E with reference to FIG. 6. As illustrated in FIG. 6, the sample 10S is placed on the five support members 216A to 216E. Each of the five support members 216A to 216E has a diameter of 7 mm, for example. A distance d1 (in particular, a distance between center axes of these support members) between the support member 216A and the support member 216B is 20 mm. A distance d2 between the support member 216B and the support member 216C is 30 mm. A distance d3 between the support member 216C and the support member 216D is 30 mm. A distance d4 between the support member 216D and the support member 216E is 20 mm.

In addition, these three support members 216B to 216D are arranged to allow a portion of the sample 10S riding between the support member 216B, the support member 216C, and the support member 216D to form a plane substantially perpendicular to the direction of gravitational force. In addition, the support member 216A and the support member 216B are arranged to allow the sample 10S to form an angle of θ1=300 relative to the above-described substantially perpendicular plane between the support member 216A and the support member 216B. Further, the support member 216D and the support member 216E are arranged to allow the sample 10S to form an angle of θ2=30° relative to the above-described substantially perpendicular plane between the support member 216D and the support member 216E. In addition, among the five support members 216A to 216E, the support member 216C is fixed not to rotate, but all of the other four support members 216A, 216B, 216D, and 216E are rotatable.

Among the support members 216A to 216E, a slit 216S is provided in the support member 216C, which is positioned between the light emitter 213 and the light receiver 214 and is positioned at substantially the center between the fixing part 217 and a portion to be loaded. Light L is irradiated from the light emitter 213 to the light receiver 214 through the slit 216S. The slit width of the slit 216S is 1 mm, and the light L is able to pass through the slit 216S without being blocked by a frame of the slit 216S.

When measuring the width of the sample 10S upon application of each load using the measuring apparatus 210, the sample 10S is first set on the measuring apparatus 210. Specifically, one end of the elongated sample 10S is fixed by the fixing part 217. Next, the sample 10S is placed on the five support members 216A to 216E. At this time, the back surface of the sample 10S is brought into contact with the five support members 216A to 216E.

Next, the measuring apparatus 210 is accommodated in a chamber controlled into a constant environment of a temperature of 25° C. and a relative humidity of 50%, and then a weight 233 for application of a load of 0.2 N is attached to the other end of the sample 10S. The sample 10S is held within the above-described environment for 2 hours or more to adapt the sample 10S to the environment. After the holding for 2 hours or more, the width of the sample 10S is measured. Specifically, the light L is irradiated from the light emitter 213 toward the light receiver 214 with a load 218 of 0.2 N being attached thereto, and the width of the sample 10S to which the load is applied in the longitudinal direction is measured. The measurement of the width is performed in a state where the sample 10S is not curled. Next, the weight for the application of a load of 0.2 N is changed to a weight for application of a load of 0.6 N to measure the width of the sample 10S five minutes after this change. Finally, the weight is changed to a weight for application of a load of 0.1 N to measure the width of the sample 10S five minutes after this change.

### (Temperature Expansion Coefficient α)

As for the temperature expansion coefficient α of the magnetic recording medium 10, it is preferable that 3 [ppm/° C.]≤α≤10 [ppm/° C.] hold true. When the temperature expansion coefficient α falls within the range mentioned above, adjustment of the tension of the magnetic recording medium 10 in the longitudinal direction by the recording/reproducing apparatus 30 described later makes it possible to suppress the change in the width of the magnetic recording medium 10.

The temperature expansion coefficient α is determined as follows. First, the sample 10S is produced in the same manner as the method of measuring the dimensional change amount Δw, and the sample 10S is set in the measuring apparatus 210 which is similar to that in the method of measuring the dimensional change amount Δw. Thereafter, the measuring apparatus 210 is accommodated in a chamber controlled into a constant environment of a temperature of 29° C. and a relative humidity of 24%. Next, a load of 0.2 N is applied in the longitudinal direction of the sample 10S, and the sample 10S is held for 2 hours or more to be adapted to the above-described environment. Thereafter, with the relative humidity of 10% being maintained, the temperature is changed in the order of 45° C., 29° C., and 10° C., the width of the sample 10S is measured at 45° C. and 10° C., and the temperature expansion coefficient α is determined by the following expression. It is to be noted that the measurement of the width of the sample 10S at a temperature of 29° C. is performed to confirm that there is no abnormality in the measurement (in particular, to confirm that these three measurement results are linear); the measurement result is not used in the following expression.

$$α [ ppm / ° C . ] = \frac{D ( 45 ° C . ) [ mm ] - D ( 10 ° C . ) [ mm ]}{D ( 10 ° C . ) [ mm ]} \times \frac{1 , 000 , 000}{( 45 [ ° C . ] ) - ( 10 [ ° C . ] )}$$

(Note that, in the expression, D (45° C.) and D (10° C.) denote respective widths of the sample 10S at temperatures of 45° C. and 10° C.)

### (Humidity Expansion Coefficient β)

As for the humidity expansion coefficient β of the magnetic recording medium 10, it is preferable that β≤5 [ppm/% RH] hold true. When the humidity expansion coefficient β falls within the range mentioned above, adjustment of the tension of the magnetic recording medium 10 in the longitudinal direction by the recording/reproducing apparatus 30 makes it possible to further suppress the change in the width of the magnetic recording medium 10.

The humidity expansion coefficient β is determined as follows. First, the sample 10S is produced in the same manner as the method of measuring the dimensional change amount Δw, and the sample 10S is set in the measuring apparatus 210 which is similar to that in the method of measuring the dimensional change amount Δw. Thereafter, the measuring apparatus 210 is accommodated in a chamber controlled into a constant environment of a temperature of 29° C. and a relative humidity of 24%. Next, a load of 0.2 N is applied in the longitudinal direction of the sample 10S, and the sample 10S is held for 2 hours or more to be adapted to the above-described environment. Thereafter, with the temperature of 29° C. being maintained, the relative humidity is changed in the order of 80%, 24%, and 10%, the width of the sample 10S is measured at 80% and 10%, and the humidity expansion coefficient β is determined by the following expression. It is to be noted that the measurement of the width of the sample 10S at a humidity of 24% is performed to confirm that there is no abnormality in the measurement (in particular, to confirm that these three measurement results are linear); the measurement result is not used in the following expression.

$$β [ ppm / \% RH ] = \frac{D ( 80 \% ) [ mm ] - D ( 10 \% ) [ mm ]}{D ( 10 \% ) [ mm ]} \times \frac{1 , 000 , 000}{( 80 [ \% ] ) - ( 10 [ \% ] )}$$

(Note that, in the expression, D (80%) and D (10%) denote respective widths of the sample 10S at relative humidities of 80% and 10%.)

### (Friction Coefficient Ratio (μB/μA))

A friction coefficient ratio (μB/μA) of the magnetic recording medium 10 between a dynamic friction coefficient μA and a dynamic friction coefficient μB is preferably 1.0 or more and 2.0 or less, more preferably 1.0 or more and 1.8 or less, and still more preferably 1.0 or more and 1.6 or less. The dynamic friction coefficient μA is a dynamic friction coefficient between the surface 13S of the magnetic layer 13 of the magnetic recording medium 10 and the magnetic head in a state where a tension of 0.4 N is applied in the longitudinal direction of the magnetic recording medium 10. The dynamic friction coefficient μB is a dynamic friction coefficient between the surface 13S of the magnetic layer 13 of the magnetic recording medium 10 and the magnetic head in a state where a tension of 1.2 N is applied in the longitudinal direction of the magnetic recording medium 10. The friction coefficient ratio (μB/μA) falling within the above-described numerical range makes it possible to reduce a change in the dynamic friction coefficient due to a variation in tension at the time of traveling, and thus to stabilize the travel of the magnetic recording medium 10.

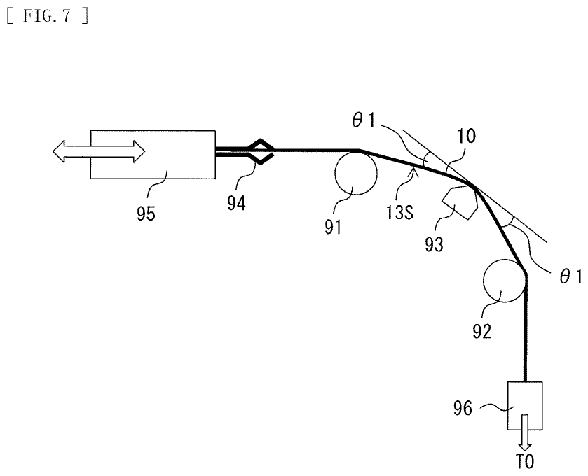

The dynamic friction coefficient μA and the dynamic friction coefficient μB for calculating the friction coefficient ratio (μB/μA) are determined as follows. First, as illustrated in FIG. 7, the magnetic recording medium 10 having a width of ½ inches is placed on two cylindrical guide rolls 91 and 92 each having a diameter of 1 inch and being parallel to each other and spaced apart from each other to allow the surface 13S of the magnetic layer 13 to be in contact with the guide rolls 91 and 92. The positional relationship between the two guide rolls 91 and 92 is fixed. It is to be noted that FIG. 7 is a schematic outline view that describes a method for measuring the dynamic friction coefficient.

Next, the magnetic recording medium 10 is brought into contact with a head block 93 (for recording and reproducing) mounted on LTO5 drive, to allow the surface 13S of the magnetic layer 13 to be in contact with the head block 93 and a holding angle θ1[° ] to be 5.6°. One end of the magnetic recording medium 10 is gripped by a holding jig 94 and linked to a movable strain gauge 95. Additionally, a weight 96 is suspended at the other end of the magnetic recording medium 10 to allow a tension T0 of 0.4 N to be imparted thereto. It is to be noted that the head block 93 is fixed at a position where the holding angle θ1[° ] is 5.6°. As a result, the positional relationship between the guide rolls 91 and 92 and the head block 93 is also fixed.

Next, the movable strain gauge 95 causes the magnetic recording medium 10 to slide 60 mm toward the movable strain gauge 95 at a rate of 10 mm/s relative to the head block 93. The output value (voltage) of the movable strain gauge 95 at the time of sliding is converted into T[N] on the basis of a previously acquired linear relationship between the output value and the load (described later). From the start to the stop of the sliding in 60 mm as described above, T[N] is acquired 13 times. Eleven T[N] except the leading one and the trailing one are simply averaged to obtain Tₐᵥₑ [N]. Thereafter, the dynamic friction coefficient μA is determined by the following expression.

$${μ}_{A} = \frac{1}{( {θ}_{1} [ ° ] ) \times ( Π / 180 )} \times ln ( \frac{{T}_{ave} [ N ]}{{T}_{0} [ N ]} )$$

The above-described linear relationship is obtained as follows. That is, the output value (voltage) of the movable strain gauge 95 is obtained for each of the case of applying a load of 0.4 N to the movable strain gauge 95 and the case of applying a load of 1.5 N to the movable strain gauge 95. From the two obtained output values and the two loads, the linear relationship between the output value and the load is obtained. Using the linear relationship, the output value (voltage) of the movable strain gauge 95 at the time of sliding is converted into T[N] as described above.

The dynamic friction coefficient μB is measured in the same manner as in the method of measuring the dynamic friction coefficient μA except that the tension T₀ [N] applied to the other end is 1.2 N.

From the dynamic friction coefficient μA and the dynamic friction coefficient μB measured as described above, the friction coefficient ratio (μB/μA) is calculated.

Assuming that a dynamic friction coefficient between the surface 13S of the magnetic layer 13 and the magnetic head is μC at the time when a tension of 0.6 N is applied to the magnetic recording medium 10, a friction coefficient ratio (μC (1000)/μC(5)) is preferably 1.0 or more and 1.9 or less, and more preferably 1.2 or more and 1.8 or less, where μC(5) is the dynamic friction coefficient in the fifth travel from the start of traveling, and μC(1000) is the dynamic friction coefficient in the 1000th travel from the start of traveling. When the friction coefficient ratio (μC(1000)/μC(5)) is 1.0 or more and 1.9 or less, it is possible to reduce a change in the dynamic friction coefficient due to the multiple travels, and thus to stabilize the travel of the magnetic recording medium 10. Here, the magnetic head used is configured to drive in conformance to the magnetic recording medium 10.

### (Friction Coefficient Ratio (μC(100)/μC(5)))

The dynamic friction coefficient μC(5) and the dynamic friction coefficient μC(1000) for calculating the friction coefficient ratio (μC(1000)/μC(5)) is determined as follows.

The friction coefficient ratio (μC(1000)/μC(5)) of the magnetic recording medium 10 is preferably 1.0 to 2.0, more preferably 1.0 to 1.8, and still more preferably 1.0 to 1.6, where μC(5) is the dynamic friction coefficient in the fifth reciprocation in a case where the magnetic recording medium to which a tension of 0.6 N is applied is reciprocated five times in the longitudinal direction on the magnetic head, and μC(1000) is the dynamic friction coefficient of the 1000th reciprocation in a case where the magnetic recording medium is reciprocated 1000 times on the magnetic head. The friction coefficient ratio (μC(1000)/μC(5)) falling within the above-described numerical ranges makes it possible to reduce the change in the dynamic friction coefficient due to the multiple travels, and thus to stabilize the travel of the magnetic recording medium 10.

The dynamic friction coefficient μC(5) and the dynamic friction coefficient μC(1000) for calculating the friction coefficient ratio (μC(1000)/μC(5)) are determined as follows.

The magnetic recording medium 10 is linked to the movable strain gauge 71 in the same manner as in the measuring method of the dynamic friction coefficient μA except that the tension T0 [N] applied to the other end of the magnetic recording medium 10 is 0.6 N. Then, the magnetic recording medium 10 is caused to slide 60 mm toward the movable strain gauge at a rate of 10 mm/s relative to the head block 74 (in an outward trip), and is caused to slide 60 mm away from the movable strain gauge (in a return trip). This reciprocating operation is repeated 1000 times. From the start to the stop of sliding in 60 mm in the fifth outward trip out of the 1000 reciprocating operations, the output value (voltage) of the strain gauge is acquired 13 times. The obtained output values are converted into T[N] on the basis of the linear relationship between the output value and the load determined using the dynamic friction coefficient μA. Eleven T[N] except the leading one and the trailing one are simply averaged to obtain Tₐᵥₑ[N]. The dynamic friction coefficient μC(5) is determined by the following expression.

$${μ}_{C ( 5 )} = \frac{1}{( {θ}_{1} [ ° ] ) \times ( π / 180 )} \times ln ( \frac{{T}_{ave} [ N ]}{{T}_{0} [ N ]} )$$

Further, the dynamic friction coefficient μC(1000) is determined in the same manner as for the dynamic friction μC(5) except that 1000th outward trip is measured.

From the dynamic friction coefficient μC(5) and the dynamic friction coefficient μC(1000) measured as described above, the friction coefficient ratio μC(1000)/μC(5) is calculated.

### (Moisture Content Rate WA)

As described above, when the weight of the magnetic recording medium 10 is set to one, the rate of the moisture content (hereinafter, referred to as a moisture content rate WA) contained in the magnetic recording medium 10 in a state of being stored in an environment of 23° C. and 45% RH for 24 hours or more is 0.64 wt % or less, for example. The moisture content rate WA may be determined by Karl Fischer method. In the measurement of the moisture content rate WA by the Karl Fischer method, the moisture amount in a substance is quantified by utilizing a specific reaction, in a titration cell, of an electrolyte (Karl Fischer reagent), containing, as main components, an iodide ion, sulfur dioxide, and alcohol, with water in the presence of methanol. For the measurement of the moisture content rate WA, for example, a “trace water-measuring apparatus Model CA-200” and a “water vaporizer Model VA-230” manufactured by Mitsubishi Chemical Analytech Co., Ltd. are used in combination. That is, a trace water-measuring apparatus Model CA-200 (hereinafter, simply referred to as CA-200) is coupled to a water vaporizer Model VA-230 (hereinafter, simply referred to as VA-230), and a sample is heated in a dried nitrogen gas stream to vaporize the moisture to be collected in an electrolyte. Then, iodine generated by electrolytic oxidation and moisture of the sample are subjected to Karl Fischer reaction, and the amount of electricity required until iodine becomes excessive is measured to quantify the moisture amount. It is to be noted that measurement conditions are as follows.
Heating temperature: 150° C.
Carrier gas type: nitrogen gas,
Carrier gas flow rate: 250 ml/min,
Carrier gas pressure: 0.1 Mpa or more and 0.2 Mpa or less,
Reagent (anolyte): Aquamicron (registered trademark of Mitsubishi Chemical
Corporation) AX, 150 ml,
Reagent (catholyte): Aquamicron (registered trademark of Mitsubishi Chemical
Corporation) CXU, 10 ml,
Titration rate: 0.2 μg/sec or less,
Stirrer rotational speed: adjustment knob set to “3”,
Measuring environment: 23° C., 45% RH

Specifically, the moisture content rate WA of the magnetic recording medium 10 is measured as follows. First, a sample of the magnetic recording medium 10 of a size of 63250 mm² is extracted from the magnetic recording cartridge 1. The sample of the magnetic recording medium 10 is stored in a measuring environment (23° C., 45% RH) for 24 hours or more, and then the weight of the sample of the magnetic recording medium 10 is weighed. The weighed sample of the magnetic recording medium 10 is immediately placed in a vial and capped. Next, confirmation is made as to whether a predetermined amount of each of the above-described anolyte and catholyte is accommodated in a bath. Next, the vial containing the sample is attached to the VA-230. Next, confirmation is made as to whether the carrier gas pressure is within the predetermined value mentioned above. Next, the power of the CA-200 is turned on. Thereafter, the flow rate of the carrier gas is adjusted to the above-mentioned predetermined value by operating a flow rate control valve, and the heating temperature of a heater is set to the above-mentioned predetermined value. Next, the adjustment knob of the stirrer rotational speed is set to “3”. Next, [Titration] button of the CA-200 is pressed to allow the inside of the electrolysis cell to be anhydrous to thereby bring it into a state where the moisture amount is measurable. After confirming that the titration rate is equal to or lower than the predetermined value and that the heating temperature is equal to the predetermined value, the measurement of the moisture amount of the sample is started by pressing [Start] button of the CA-200. When the measurement value of the moisture amount is obtained, the obtained measurement value is divided by the weight of the previously weighed sample to obtain the moisture content rate WA.

### 1-3. Method of Manufacturing Magnetic Recording Medium 10

Next, description is given of a method of manufacturing the magnetic recording medium 10 having the above-described configuration. First, a coating material for forming an underlayer is prepared by kneading and dispersing non-magnetic powders, a binder, a lubricant, and the like in a solvent. Next, a coating material for forming a magnetic layer is prepared by kneading and dispersing magnetic powders, a binder, a lubricant, and the like in a solvent. Next, a coating material for forming a back layer is prepared by kneading and dispersing a binder, non-magnetic powders, and the like in a solvent. To prepare the coating material for forming a magnetic layer, the coating material for forming an underlayer, and the coating material for forming a back layer, the following solvents, dispersion apparatus, and kneading apparatus may be used, for example.

Examples of the solvent used for preparing the above-mentioned coating materials include: a ketone-based solvent, such as acetone, methyl ethyl ketone, methyl isobutyl ketone, or cyclohexanone; an alcohol-based solvent, such as methanol, ethanol, or propanol; an ester-based solvent, such as methyl acetate, ethyl acetate, butyl acetate, propyl acetate, ethyl lactate, or ethylene glycol acetate; an ether-based solvent, such as diethylene glycol dimethyl ether, 2-ethoxyethanol, tetrahydrofuran, or dioxane; an aromatic hydrocarbon solvent, such as benzene, toluene, or xylene; and a halogenated hydrocarbon solvent, such as methylene chloride, ethylene chloride, carbon tetrachloride, chloroform, or chlorobenzene. These may be used alone, and may be used in combination as appropriate.

Examples of the kneading apparatus used for the preparation of the above-mentioned coating materials may include, but not particularly limited to, a continuous twin-screw kneader, a continuous twin-screw kneader allowing for dilution in multiple stages, a kneader, a pressure kneader, a roll kneader, and other kneading apparatuses. In addition, examples of the dispersing apparatus used for the preparation of the above-mentioned coating materials may include, but not particularly limited to, a roll mill, a ball mill, a transverse sand mill, a longitudinal sand mill, a spike mill, a pin mil, a tower mil, a pearl mill (e.g., “DCP mill” manufactured by Eirich Co., Ltd., etc.), a homogenizer, an ultrasonic disperser, and other dispersing apparatuses.

Next, the coating material for forming an underlayer is applied to one main surface 11A of the substrate 11 and dried to thereby form the underlayer 12. Subsequently, the coating material for forming a magnetic layer is applied onto the underlayer 12 and dried to thereby form the magnetic layer 13 on the underlayer 12. It is to be noted that, during the drying, it is preferable to cause the magnetic field of the magnetic powders to be oriented in the thickness direction of the substrate 11 by a solenoidal coil, for example. Alternatively, during the drying, the magnetic field of the magnetic powders may be oriented in the traveling direction (longitudinal direction) of the substrate 11, and thereafter oriented in the thickness direction of the substrate 11 by a solenoidal coil, for example. Such magnetic field orientation processing makes it possible to improve the degree of vertical orientation (i.e., squareness ratio S1) of the magnetic powders. After the magnetic layer 13 is formed, the coating material for forming a back layer is applied to the other main surface 11B of the substrate 11 and dried to thereby form the back layer 14. This allows the magnetic recording medium 10 to be obtained.

The squareness ratios S1 and S2 are set to desired values by, for example, adjusting the intensity of the magnetic field applied to the coated film of the coating material for forming a magnetic layer, the concentration of a solid content in the coating material for forming a magnetic layer, and drying conditions (drying temperatures and drying times) for the coated film of the coating material for forming a magnetic layer. The intensity of the magnetic field applied to the coated film is preferably at least twice the coercivity of the magnetic powders. In order to further increase the squareness ratio S1 (i.e., in order to further lower the squareness ratio S2), it is preferable to improve the dispersing state of the magnetic powders in the coating material for forming a magnetic layer. In addition, in order to further increase the squareness ratio S1, it is also effective to magnetize the magnetic powders at a stage prior to the application of the coating material for forming a magnetic layer to an alignment apparatus for causing the magnetic field of the magnetic powders to be oriented. It is to be noted that the above-mentioned methods of adjusting the squareness ratios S1 and S2 may be used alone, or two or more of them may be used in combination.

Thereafter, the obtained magnetic recording medium 10 is subjected to calendering processing to planarize the surface 13S of the magnetic layer 13. Next, the magnetic recording medium 10 subjected to the calendar processing is wound into a roll shape.

Finally, the magnetic recording medium 10 is cut to have a predetermined width (e.g., ½ inch wide). This allows the magnetic recording medium 10 to be obtained as desired.

It is to be noted that the moisture content rate of the magnetic recording medium 10 in a state of being stored in the environment of 23° C. and 45% RH for 24 hours or more can be adjusted, for example, as follows.
(A) The heating temperature and heating time are adjusted in each drying step after application of each coating material for configuring the underlayer 12, the magnetic layer 13, and the back layer 14.
(B) After the calendering processing, the magnetic recording medium 10 is passed through a drying furnace at 100° C. or more (e.g., 110° C.), before cutting, to volatilize the moisture contained in the magnetic recording medium 10.
(C) Before the application of each coating material, only the substrate 11 is caused to travel in vacuo and rewound around another core.
(D) Before the application of each coating material, only the substrate 11 wound around the core is stored in vacuo for a predetermined period of time (e.g. 24 hours). It is considered that the processing of any of (A) to (D) desorbs the moisture content adsorbed to the inside of the magnetic recording medium and causes a binder, a lubricant, or the like to adsorb to a portion of the desorption instead, thereby making it possible to adjust the amount of the moisture newly adsorbed in the magnetic recording medium.

### 2-4. Recording/Reproducing Apparatus 30

### (Configuration Recording/Reproducing Apparatus 30)

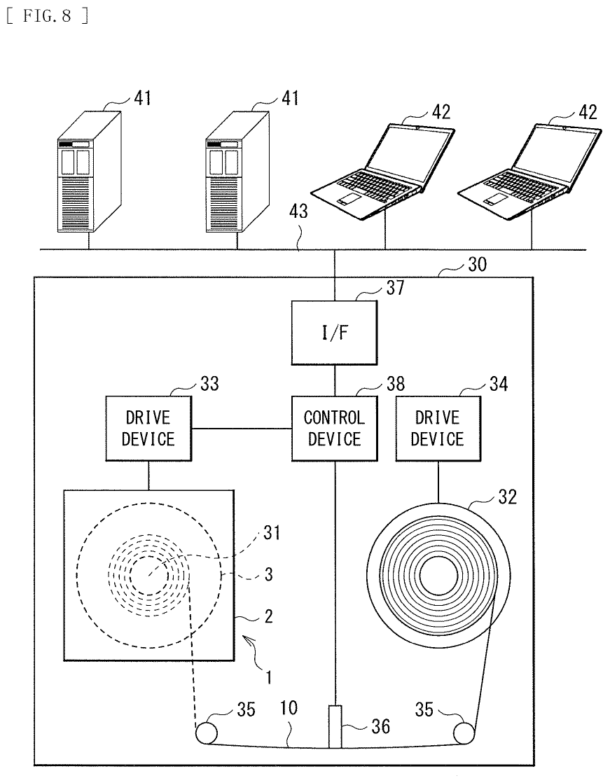

Next, description is given, with reference to FIG. 8, of the configuration of the recording/reproducing apparatus 30 for recording information on the above-described magnetic recording medium 10 and reproducing information from the above-described magnetic recording medium 10.

The recording/reproducing apparatus 30 has a configuration in which a tension applied in the longitudinal direction of the magnetic recording medium 10 is adjustable. In addition, the recording/reproducing apparatus 30 has a configuration in which the magnetic recording cartridge 1 is loadable. Here, for ease of explanation, the recording/reproducing apparatus 30 has a configuration in which one magnetic recording cartridge 1 is loadable. However, in the present disclosure, the recording/reproducing apparatus 30 may have a configuration in which a plurality of magnetic recording cartridges 1 is loadable. As described above, the magnetic recording medium 10 may have a tape-like shape, and may be, for example, an elongated magnetic recording tape. The magnetic recording medium 10 may be accommodated in a housing in a state of being wound around a reel inside the magnetic recording cartridge 1, for example. The magnetic recording medium 10 is configured to travel in the longitudinal direction during recording and reproduction. In addition, the magnetic recording medium 10 may be configured to be able to record signals at a shortest recording wavelength of preferably 100 nm or less, more preferably 75 nm or less, still more preferably 60 nm or less, and particularly preferably 50 nm or less. The magnetic recording medium 10 may be used in the recording/reproducing apparatus 30 having, for example, a shortest recording wavelength within the above ranges. The recording track width may be, for example, 2 μm or less.

The recording/reproducing apparatus 30 is coupled to information processing apparatuses, such as servers 41 and personal computers 42 (hereinafter referred to “PCs”), via a network 43, for example. The recording/reproducing apparatus 30 is configured to be able to record data supplied from these information processing apparatuses in the magnetic recording medium cartridge 10A.

As illustrated in FIG. 8, the recording/reproducing apparatus 30 includes, for example, a spindle 31, a reel 32, a drive device 33, a drive device 34, a plurality of guide rollers 35, a head unit 36, a communication interface (hereinafter, referred to as I/F) 37, and a control device 38.

The spindle 31 is configured such that, for example, the magnetic recording cartridge 1 is mountable thereon. The magnetic recording cartridge 1 conforms to the LTO (Linear Tape Open) standard, and has the cartridge case 2 rotatably accommodating a single reel 3 around which the magnetic recording medium 10 is wound. An inverted V-shaped servo pattern is preliminarily recorded, as a servo signal, in the magnetic recording medium 10. The reel 32 is configured to fix a leading end of the magnetic recording medium 10 drawn out from the magnetic recording cartridge 1.

The drive device 33 is a device for rotationally driving the spindle 31. The drive device 34 is a device for rotationally driving the reel 32. When data is recorded on or reproduced from the magnetic recording medium 10, the drive device 33 and the drive device 34 respectively rotate the spindle 31 and the reel 32 to cause the magnetic recording medium 10 to travel. The guide rollers 35 are rollers for guiding the travel of the magnetic recording medium 10.

The head unit 36 includes a plurality of recording heads for recording data signals in the magnetic recording medium 10, a plurality of reproducing heads for reproducing data signals recorded on the magnetic recording medium 10, and a plurality of servo heads for reproducing servo signals recorded on the magnetic recording medium 10. For example, a ring-type head may be used as the recording head, and a magnetoresistive effect-type magnetic head may be used as the reproducing head, for example. However, the types of the recording head and the reproducing head are not limited thereto.

The I/F 37 is directed to communicating with the information processing apparatuses such as the servers 41 and the PCs 42, and is coupled to the network 43.

The control device 38 controls the entire recording/reproducing apparatus 30. For example, the control device 38 records data signals supplied from the information processing apparatuses in the magnetic recording medium 10 using the head unit 36 in response to requests from the information processing apparatuses such as the servers 41 and the PCs 42. In addition, the control device 38 reproduces the data signal recorded on the magnetic recording medium 10 using the head unit 36 in response to requests from the information processing apparatuses such as the servers 41 and the PCs 42, and supplies the reproduced data signals to the information processing apparatuses.

### (Operation of Recording/Reproducing Apparatus)

Next, description is given of operations of the recording/reproducing apparatus 30 having the above configuration.

First, the magnetic recording cartridge 1 is mounted on the recording/reproducing apparatus 30. The leading end of the magnetic recording medium 10 is drawn out, and transferred to the reel 32 via the plurality of guide rollers 35 and the head unit 36, to attach the leading end of the magnetic recording medium 10 to the reel 32.

Next, when an unillustrated operation unit is operated, the spindle drive device 33 and the reel drive device 34 are driven under the control of the control device 38, thereby rotating the spindle 31 and the reel 32 in the same direction to allow the magnetic recording medium 10 to travel from the reel 3 toward the reel 32. This allows the head unit 36 to record information on the magnetic recording medium 10 or reproduce information recorded on the magnetic recording medium 10 while allowing the magnetic recording medium 10 to be wound around the reel 32.

In addition, in a case of rewinding the magnetic recording medium 10 around the reel 3, the spindle 31 and the reel 32 are rotationally driven in a direction opposite to the above-described direction, thereby allowing the magnetic recording medium 10 to travel from the reel 32 to the reel 3. Also in this rewinding, the head unit 36 records information on the magnetic recording medium 10 or reproduces information recorded on the magnetic recording medium 10.

### 2-5. Effects

As described above, the magnetic recording medium 10 of the present embodiment is a tape-shaped member in which the substrate 11, the underlayer 12, and the magnetic layer 13 are stacked in order. When the weight of the magnetic recording medium 10 is set to one, a rate of a moisture content (moisture content rate WA) contained in the magnetic recording medium 10 in a state of being stored in an environment of 23° C. and 45% RH for 24 hours or more is set to 0.64 wt % or less.

The magnetic recording medium 10 of the present embodiment has such a configuration, i.e., optimizes the amount of moisture of the magnetic recording medium 10, thereby allowing the magnetic recording medium to absorb and remove the moisture even in a case where the environmental temperature changes. This makes it possible to stabilize the relative humidity within a tape-travel environment and thus to suppress the occurrence of condensation. As a result, for example, the application thereof to the recording/reproducing apparatus 30 makes it possible to avoid sticking between the surface 13S of the magnetic layer 13 and the magnetic head. Therefore, when performing recording on the magnetic recording medium 10 and when performing reproducing from the magnetic recording medium 10, it is possible to perform stable traveling while favorably maintaining contact between the surface 13S of the magnetic layer 13 and the magnetic head.

The moisture content rate in the magnetic recording medium as a finished product has not been sufficiently controlled. For example, in the magnetic recording medium manufactured by a coating method, raw materials to be used in the manufacturing stage have been controlled to allow respective moisture content rates thereof to fall within a predetermined range. However, the moisture content rate of the magnetic recording medium itself finally obtained at the time when being stored in an environment of 23° C. and 45% RH for 24 hours or more has not been controlled. Therefore, for example, as for a magnetic recording cartridge incorporating a magnetic recording medium having the moisture content rate WA exceeding 0.64 wt % at the time of being stored in an environment of 23° C. and 45% RH for 24 hours or more, in a case where the environmental conditions around the magnetic recording medium upon being used for recording and reproducing rapidly change, for example, from the room temperature (e.g., 23° C.) to a low temperature (e.g., 5° C.), there is a possibility that moisture in the surrounding environment may not be sufficiently absorbed by the magnetic recording medium, causing condensation to occur on the surface thereof. This results in occurrence of stiction between the surface of the magnetic layer and the magnetic head, which prevents the magnetic recording medium from stably traveling. In this respect, according to the magnetic recording medium 10 of the present disclosure, even when the environmental temperature rapidly decreases, it is sufficiently possible to absorb the moisture in the surrounding environment of the magnetic recording medium, thus no condensation occurs on the surface 13S of the magnetic layer 13. As a result, it is possible to avoid the sticking between the surface 13S of the magnetic layer 13 and the magnetic head and thus to perform stable traveling.

In addition, when the weight of the magnetic recording medium 10 is set to one, the rate of the moisture content (moisture content rate WA) contained in the magnetic recording medium 10 having been stored in an environment of 23° C. and 45% RH for 24 hours or more is preferably 0.2 wt % or more. One reason for this is that setting the moisture content rate WA to 0.2% or more makes it possible to stably maintain the shape of the magnetic recording medium.

### 2-6. Modification Examples

### Modification Example 1

In the foregoing first embodiment, the ε-iron oxide particle 20 including the shell part 22 of a two-layer structure (FIG. 4) has been exemplified and described. However, the magnetic recording medium of the present technology may include an ε-iron oxide particle 20A including a shell part 23 of a single layer structure, as illustrated in FIG. 19, for example. The shell part 23 of the ε-iron oxide particle 20A has, for example, a configuration similar to that of the first shell part 22a. However, from the viewpoint of suppressing the characteristic deterioration, the F-iron oxide particle 20 having the shell part 22 of the two-layer structure described in the foregoing first embodiment is more preferable than the ε-iron oxide particle 20A of Modification Example 1.

### Modification Example 2

In the magnetic recording medium 10 of the embodiment described above, the ε-iron oxide particle 20 having a core-shell structure has been exemplified and described. However, the ε-iron oxide particle may contain an additive instead of the core-shell structure, or may have the core-shell structure and an additive. In this case, a portion of Fe of the ε-iron oxide particle is substituted with an additive. With the ε-iron oxide particle including an additive, it is also possible to adjust the coercivity He of the entire ε-iron oxide particle to a coercivity He suitable for recording, and thus to improve the ease of recording. The additive is a metal element other than iron, preferably a trivalent metal element, more preferably at least one of Al (aluminum), Ga (gallium) or In (indium), still more preferably at least one of Al or Ga.

Specifically, the ε-iron oxide including an additive is an ε-Fe₂−xMxO₃ crystal (where M is a metal element other than iron, preferably a trivalent metal element, more preferably at least one of Al, Ga or In, still more preferably at least one of Al or Ga, and x satisfies, for example, 0<x<1).

### Modification Example 3

The magnetic powders of the present disclosure may include nanoparticle powders that contain hexagonal ferrite (hereinafter referred to as “hexagonal ferrite particle”) instead of the ε-iron oxide particle powders. The hexagonal ferrite particle has a hexagonal plate-like or substantially hexagonal plate-like shape, for example. The hexagonal ferrite includes preferably at least one of Ba (barium), Sr (strontium). Pb (lead) or Ca (calcium), and more preferably at least one of Ba or Sr. Specifically, the hexagonal ferrite may be barium ferrite or strontium ferrite, for example. The barium ferrite may further include at least one of Sr, Pb, or Ca in addition to Ba. The strontium ferrite may further include at least one of Ba, Pb or Ca in addition to Sr.

More specifically, the hexagonal ferrite has an average composition represented by the general formula MFe₁₂O₁₉, where M is, for example, at least one metal of Ba, Sr, Pb or Ca, and preferably at least one metal of Ba or Sr. M may be a combination of Ba and one or more metals selected from the group consisting of Sr, Pb, and Ca. Alternatively, M may be a combination of Sr and one or more metals selected from the group consisting of Ba, Pb, and Ca. In the above general formula, a portion of Fe may be substituted with another metal element.

In a case where the magnetic powders include hexagonal ferrite particle powders, the average particle size of the magnetic powders is preferably 50 nm or less, more preferably 40 nm or less, and still more preferably 30 nm or less. More preferably, the average particle size of the magnetic powders is 25 nm or less, 22 nm or less, 21 nm or less, or 20 nm or less. In addition, the average particle size of the magnetic powders is, for example, 10 nm or more, preferably 12 nm or more, and still preferably 15 nm or more. Therefore, the average particle size of the magnetic powders including the hexagonal ferrite particle powders may be, for example, 10 nm or more and 50 nm or less, 10 nm or more and 40 nm or less, 12 nm or more and 30 nm or less, 12 nm or more and 25 nm or less, or 15 nm or more and 22 nm or less. In a case where the average particle size of the magnetic powders is equal to or smaller than the above-described upper limit value (e.g., 50 nm or less, particularly 30 nm or less), it is possible to obtain favorable electromagnetic conversion characteristics (e.g., SNR) of the magnetic recording medium 10 having a high recording density. In a case where the average particle size of the magnetic powders is equal to or larger than the above-described lower limit value (e.g., 10 nm or more, preferably 12 nm or more), it is possible to further improve the dispersibility of the magnetic powders and to obtain more excellent electromagnetic conversion characteristics (e.g., SNR).

In a case where the magnetic powders include hexagonal ferrite particle powders, the average aspect ratio of the magnetic powders may be preferably 1 or more and 3.5 or less, more preferably 1 or more and 3.1 or less or 2 or more and 3.1 or less, and still more preferably 2 or more and 3 or less. When the average aspect ratio of the magnetic powders is within the above-described numerical ranges, it is possible to suppress aggregation of the magnetic powders. Further, when the magnetic powders are oriented perpendicularly in the step of forming the magnetic layer 13, it is possible to suppress the resistance applied to the magnetic powders. This may improve the vertical orientation of the magnetic powders.

It is to be noted that the average particle size and the average aspect ratio of the magnetic powder including hexagonal ferrite particle powders are determined as follows. First, the magnetic recording medium 10 to be measured is processed by the FIB (Focused Ion Beam) method or the like into a thin piece. The thinning is performed along the length direction (longitudinal direction) of the magnetic tape. The cross-section of the obtained thin sample piece is observed using a transmission electron microscope (H-9500 manufactured by Hitachi High-Technologies) at an acceleration voltage of 200 kV and total magnification of 500,000 times, in such a manner that the recording layer is entirely included in the thickness direction of the recording layer. Next, 50 particles having a side face oriented toward the surface to be observed are selected from a TEM photograph captured, and the maximum plate thickness DA of each of the particles is measured. The maximum plate thicknesses DA obtained in such a manner are simply averaged (arithmetically averaged) to determine an average maximum plate thickness DAave. Subsequently, a plate diameter DB of each of the magnetic powders is measured. Here, the plate diameter DB refers to the maximum distance between any two parallel lines drawn from any angles so as to contact the contour of the magnetic powder (so-called maximum Feret diameter). Subsequently, the measured plate diameters DB are simply averaged (arithmetically averaged) to determine an average plate diameter DBave. Then, an average aspect ratio (DBave/DAave) of the particles is determined from the average maximum plate thickness DAave and the average plate diameter DBave.

In a case where the magnetic powders include hexagonal ferrite particle powders, the average particle volume of the magnetic powders is preferably 400 nm³ or more and 1800 nm³ or less. When the average particle volume of the magnetic powders is 1800 nm³ or less, it is possible to obtain favorable electromagnetic conversion characteristics (e.g., SNR) required as the magnetic recording medium 10 having a high recording density. When the average particle volume of the magnetic powders is 400 nm³ or more, it is possible, for example, to sufficiently ensure thermal stability in the magnetic layer 13 and to favorably maintain the recording state in the magnetic layer 13.

It is to be noted that the average particle volume of the magnetic powders is determined as follows. First, the average maximum plate thickness DAave and the average maximum plate diameter DBave are determined by the method of calculating the average particle size of the magnetic powders described above. Next, the average particle volume V of the magnetic powders is determined by the following expression.

$$V = \frac{3 \sqrt{3}}{8} \times {DA}_{ave} \times {DB}_{ave} \times {DB}_{ave}$$

According to a particularly preferred embodiment of the present technology, the magnetic powders may be barium ferrite magnetic powders or strontium ferrite magnetic powders, more preferably barium ferrite magnetic powders. The barium ferrite magnetic powders include magnetic particles of iron oxide having barium ferrite as a main phase (hereinafter referred to as “barium ferrite particles”). The barium ferrite magnetic powders have high reliability of the data recording; for example, the coercivity does not decrease even in a high temperature and humidity environment. From this viewpoint, the barium ferrite magnetic powders are preferable as the magnetic powders.

In a case where the magnetic layer 13 includes the barium ferrite magnetic powders as the magnetic powders, an average thickness tm [nm] of the magnetic layer 13 is preferably 35 nm≤tm≤100 nm, and particularly preferably 80 nm or less. In addition, the coercivity He measured in the thickness direction (perpendicular direction) of the magnetic recording medium 10 is preferably 160 kA/m or more and 280 kA/m or less, more preferably 165 kA/m or more and 275 kA/m or less, and still more preferably 170 kA/m or more and 270 kA/m or less.

### Modification Example 4

The magnetic powders may include nanoparticles containing Co-containing spinel ferrite (hereinafter referred to as “cobalt ferrite particles”), instead of the ε-iron oxide particle powders. The cobalt ferrite particles preferably have uniaxial anisotropy. The cobalt ferrite particles, for example, have a cubic or substantially cubic shape. The Co-containing spinel ferrite may further include at least one of Ni, Mn, Al, Cu or Zn in addition to Co.

The Co-containing spinel ferrite has, for example, an average composition represented by the following formula:

CoₓM_{y}Fe₂O_{z}
(where, in Expression (1), M is, for example, a metal of at least one of Ni, Mn, Al, Cu or Zn, x is a value within the range of 0.4≤x≤1.0, and y is a value within the range of 0≤y≤0.3. Note that x and y satisfy the relationship (x+y)≤1.0, z is a value within the range of 3≤z≤4, and Fe may be partially substituted with another metal element).

When the magnetic powders include cobalt ferrite particle powders, the average particle size of the magnetic powders is preferably 25 nm or less, and more preferably 10 nm or more and 23 nm or less. When the average particle size of the magnetic powders is 25 nm or less, it is possible to obtain favorable electromagnetic conversion characteristics (e.g., SNR) of the magnetic recording medium 10 having a high recording density. Meanwhile, when the average particle size of the magnetic powders is 10 nm or more, it is possible to further improve the dispersibility of the magnetic powders and to obtain more excellent electromagnetic conversion characteristics (e.g., SNR). In a case where the magnetic powders include the cobalt ferrite particle powders, the average aspect ratio of the magnetic powders is similar to that of the foregoing embodiment. In addition, the average particle size and the average aspect ratio of the magnetic powders are also determined in the same manner as the calculation method of the foregoing embodiment.

The average particle volume of the magnetic powders is preferably 15000 nm³ or less, and more preferably 1000 nm³ or more and 12000 nm³ or less. When the average particle volume of the magnetic powders is 15000 nm³ or less, it is possible to obtain effects similar to those in the case where the average particle size of the magnetic powders is 25 nm or less. Meanwhile, when the average particle volume of the magnetic powders is 1000 nm³ or more, it is possible to obtain effects similar to those in the case where the average particle size of the magnetic powders is 10 nm or more. It is to be noted that the average particle volume of the magnetic powders is determined in the same manner as the method of calculating the average particle volume of the magnetic powders in the foregoing first embodiment (the method of calculating the average particle volume in the case where the ε-iron oxide particle has a cubic or substantially cubic shape).

The coercivity He of the cobalt ferrite magnetic powders is preferably 2500 Oe or more, and more preferably 2600 Oe or more and 3500 Oe or less.

### Modification Example 5

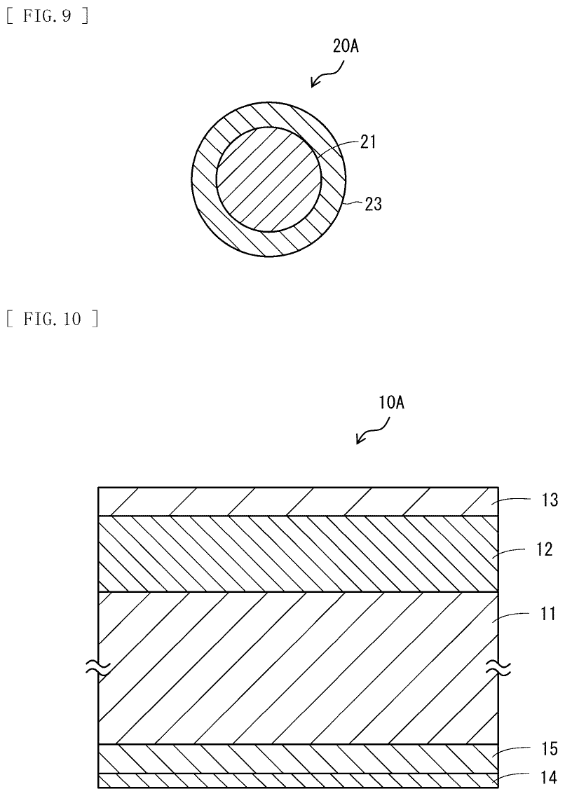

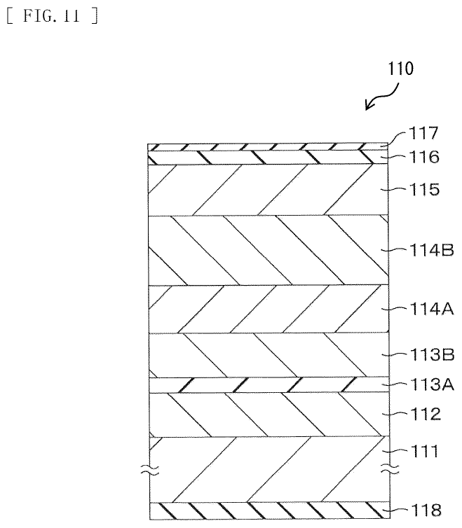

As in a magnetic recording medium 10A illustrated in FIG. 10, for example, the magnetic recording medium of the present embodiment may further include a barrier layer 15 provided on at least one surface of the substrate 11. The barrier layer 15 is a layer for suppressing a dimensional change of the substrate 11 depending on an environment. For example, one example cause of the dimensional change is a hygroscopic property of the substrate 11. It is possible to reduce the rate of water penetration into the substrate 11 by providing the barrier layer 15. The barrier layer 15 includes, for example, a metal or a metal oxide. Here, the metal may be, for example, at least one of Al, Cu, Co, Mg, Si, Ti, V, Cr, Mn, Fe, Ni, Zn, Ga, Ge, Y, Zr, Mo, Ru, Pd, Ag, Ba, Pt, Au, or Ta. The metal oxide may be, for example, a metal oxide containing one or more of the above metals. More specifically, for example, at least one of Al₂O₃, CuO, CoO, SiO₂, Cr₂O₃, TiO₂, Ta₂O₅, or ZrO₂. In addition, the barrier layer 15 may include diamond-like carbon (DLC) or diamond.

The average thickness of the barrier layer 15 is preferably 20 nm or more and 1000 nm or less, and more preferably 50 nm or more and 1000 nm or less. The average thickness of the barrier layer 15 is determined in the same manner as for the average thickness of the magnetic layer 13. Note that the magnification of the TEM image is appropriately adjusted depending on the thickness of the barrier layer 15.

### Modification Example 6

The magnetic recording medium 10 according to the foregoing embodiment may be used in a library apparatus. In this case, the library apparatus may include a plurality of recording/reproducing apparatuses 30 of the foregoing embodiment.

### 3. SECOND EMBODIMENT (AN EXAMPLE OF A MAGNETIC RECORDING CARTRIDGE INCLUDING A SPUTTERED MAGNETIC RECORDING MEDIUM)

### 3-1. Configuration of Magnetic Recording Cartridge 1

The magnetic recording cartridge 1 of the present embodiment is the same as the magnetic recording cartridge 1 described in the foregoing first embodiment except that a sputtered magnetic recording medium 110 is included instead of the coated magnetic recording medium 10.

### 3-2. Configuration of Magnetic Recording Medium 110

FIG. 11 schematically illustrates a cross-sectional configuration example of the magnetic recording medium 110. The magnetic recording medium 110 is an elongated perpendicular magnetic recording medium, and has a stacked structure in which a plurality of layers are stacked as illustrated in FIG. 11. Specifically, the magnetic recording medium 110 includes, in order, an elongated tape-like substrate 111, a first seed layer 113A, a second seed layer 113B, a first underlayer 114A, a second underlayer 114B, and a magnetic layer 115. Here, an SUL 112, the first seed layer 113A, the second seed layer 113B, the first underlayer 114A, the second underlayer 114B, and the magnetic layer 115 may be, for example, a sputtered film formed by a sputtering method.

The magnetic recording medium 110 may further include, on the magnetic layer 115, a protective film 116 and a lubricating layer 117, in order. In addition, the magnetic recording medium 110 may further include a back layer 118 provided on a second main surface of the substrate 111. In addition, a soft magnetic underlayer (Soft magnetic underlayer; SUL) 112 may be further provided on a first main surface of the substrate 111.

Hereinafter, the longitudinal direction of the magnetic recording medium 110 (longitudinal direction of the substrate 111) is referred to as a machine direction (MD: Machine Direction). Here, the machine direction means a relative movement direction of the recording and reproducing heads with respect to the magnetic recording medium 110, i.e., a direction in which the magnetic recording medium 110 travels upon recording/reproducing.

The magnetic recording medium 110 is suitable for use as a storage medium for data archive, which is expected to be demanded increasingly in the future. This magnetic recording medium 110 is able to achieve, for example, a surface recording density that is ten times or more as high as that of a current coated magnetic recording medium for storage, i.e., a surface recording density of 50 Gb/inch² or more. In a case where a common linear-recording data cartridge is configured with the use of the magnetic recording medium 110 which has such a high surface recording density, it is possible to record a large capacity of 100 TB or more per magnetic recording cartridge.

The magnetic recording medium 110 is able to be suitably used in a recording/reproducing apparatus (a recording/reproducing apparatus for recording and reproducing data) including a ring-type recording head and a giant magnetoresistive (Giant Magnetoresistive: GMR) type or tunneling magnetoresistive (Tunneling Magnetoresistive: TMR) type reproducing head. In addition, for the magnetic recording medium 110, a ring-type recording head is preferably used as a servo-signal writing head. On the magnetic layer 115, a data signal is perpendicularly recorded, for example, by a ring-type recording head. In addition, on the magnetic layer 115, a servo signal is perpendicularly recorded, for example, by a ring-type recording head.

When the weight of the magnetic recording medium 110 is set to one, the rate of the moisture content contained in the magnetic recording medium 110 is favorably 0.2 wt % or more and 0.64 wt % or less, for example. The rate of the moisture content contained in the magnetic recording medium 110 is particularly preferably 0.3 wt % or less. It is to be noted that the rate of the moisture content contained in the magnetic recording medium 110 is also synonymous with the rate of the moisture content contained in the magnetic recording medium 10 of the foregoing first embodiment. That is, the rate of the moisture content contained in the magnetic recording medium 110 is a rate of moisture content contained in the magnetic recording medium 110 in a stabilized state in an environment of a temperature of 23° C. and a relative humidity of 45% RH. The rate of the moisture content contained in the magnetic recording medium 110 does not refer to a moisture content rate for a dried magnetic recording medium in a temporary special environment, e.g., in a high-temperature vacuum environment. The rate of the moisture content contained in the magnetic recording medium 110 means a moisture content rate in the magnetic recording medium 110 placed in an environment of a temperature of 23° C. and a relative humidity of 45% RH for at least 24 hours. In addition, an average thickness of the magnetic recording medium 110 is, for example, 4.0 μm or more and 5.8 μm or less, and particularly favorably 4.7 μm or more and 5.3 μm or less. In addition, a total surface area of the magnetic recording medium 110 wound around the reel 3 of the magnetic recording cartridge 1 is, for example, 6.3 m² or more and 25 m² or less, more preferably 12 m² or more and 25 m² or less, and still more preferably 15 m² or more and 25 m² or less. It is to be noted that the total length of the magnetic recording medium 110 wound around the reel 3 of the magnetic recording cartridge 1 is, for example, 1000 m. As used herein, the total surface area of the magnetic recording medium 110 is substantially synonymous with the total surface area of the magnetic recording medium 10. That is, the total surface area of the magnetic recording medium 110 refers to the total sum of the area on a side of the surface where the magnetic layer 115 is provided as viewed from the substrate 111, not including the area on a side of the surface where the back layer 118 is provided as viewed from the substrate 111. Specifically, the total surface area is determined by (total length of the magnetic recording medium 110 included in the magnetic recording cartridge 1)×(width of the magnetic recording medium 110). It is to be noted that, the total surface area of the magnetic recording medium 110 as used herein does not include an area of the surface, of the magnetic recording medium 110, corresponding to a region where the magnetic layer 115 is not formed.

### (Substrate 111)

For the substrate 111, a substrate having substantially the same configuration as that of the substrate 11 in the magnetic recording medium 10 of the foregoing first embodiment may be used. Therefore, detailed description of the substrate 111 is omitted.

### (SUL 112)

The SUL 112 includes a soft magnetic material in an amorphous state. The soft magnetic material includes, for example, at least one of a Co-based material or an Fe-based material. The Co-based material contains, for example, CoZrNb, CoZrTa, or CoZrTaNb. The Fe-based material contains, for example, FeCoB, FeCoZr, or FeCoTa.

The SUL 112 has a single-layer structure, for example, and is provided directly on the substrate 111. The average thickness of the SUL 112 is preferably 10 nm or more and 50 nm or less, and more preferably 20 nm or more and 30 nm or less. The average thickness of the SUL 112 can be determined, for example, in the same manner as the method of measuring the average thickness of the magnetic layer 13 according to the first embodiment. It is to be noted that the average thicknesses of the layers other than the SUL 112, i.e., the average thicknesses of the first seed layer 113A, the second seed layer 113B, the first underlayer 114A, the second underlayer 114B, and the magnetic layer 115 are also able to be determined in the same manner as the method of measuring the average thickness of the magnetic layer 13.

### (First Seed Layer 113A and Second Seed Layer 113B)

The first seed layer 113A includes an alloy containing Ti and Cr, and contains a substance in an amorphous state. In addition, this alloy may further contain O (oxygen). This oxygen may be impurity oxygen contained in a small amount in the first seed layer 113A upon deposition of the first seed layer 113A by a deposition method such as a sputtering method. As used herein, the alloy means at least one of a solid solution, a eutectic, or an intermetallic compound containing Ti and Cr. In addition, the amorphous state means that halo is observed by an X-ray diffraction, an electron beam diffraction method, or the like, thereby failing to identify a crystalline structure of a substance configuring the first seed layer 113.

The atomic ratio of Ti to the total amount of Ti and Cr contained in the first seed layer 113A is preferably 30 atomic % or more and less than 100 atomic %, more preferably 50 atomic % or more and less than 100 atomic %. When the atomic ratio of Ti is less than 30%, (100) plane of a body-centered cubic lattice (Body-Centered Cubic lattice: bcc) structure of Cr is oriented, and there is a possibility that the orientations of the first underlayer 114A and the second underlayer 114B formed on the first seed layer 113A may be degraded.

The above-described atomic ratio of Ti is determined as follows. A depth profile analysis (depth profile measurement) of the first seed layer 113A is made by Auger electron spectroscopy (Auger Electron Spectroscopy: AES) while ion-milling the magnetic recording medium 110 from a side of the magnetic layer 115. Next, the average composition (average atomic ratio) of Ti and Cr in the film thickness direction is determined from the obtained depth profile. Next, the above-described atomic ratio of Ti is determined with the use of the obtained average composition of Ti and Cr.

In a case where the first seed layer 113A contains Ti, Cr, and O, the atomic ratio of O to the total amount of Ti, Cr, and O contained in the first seed layer 113A is preferably 15 atomic % or less, and more preferably 10 atomic % or less. When the atomic ratio of O exceeds 15 atomic %, generation of TiO₂ crystals affects the formation of crystal nuclei for the first underlayer 114A and the second underlayer 114B formed on the first seed layer 113A, and there is a possibility that the orientations of the first underlayer 114A and the second underlayer 114B may be degraded. The above-described atomic ratio of O is determined with the use of an analysis method similar to that for the above-described atomic ratio of Ti.

The alloy included in the first seed layer 113A may further contain elements other than Ti and Cr as additive elements. Examples of the additive elements may include one or more elements selected from the group consisting of Nb, Ni, Mo, Al, and W.

The average thickness of the first seed layer 113A is preferably 1 nm or more and 15 nm or less, and more preferably 1 nm or more and 10 m or less.

The second seed layer 113B contains, for example, NiW or Ta, and has a crystalline state. The average thickness of the second seed layer 113B is preferably 2 nm or more and 20 nm or less, and more preferably 3 nm or more and 15 nm or less.

The first seed layer 113A and the second seed layer 113B are not seed layers provided for the purpose of crystalline growth of the first underlayer 114A and the second underlayer 114B. The first seed layer 113A and the second seed layer 113B are seed layers that improve the vertical orientation of the first underlayer 114A and the second underlayer 114B.

### (First Underlayer 114A and Second Underlayer 114B)

The first underlayer 114A and the second underlayer 114B preferably have a crystalline structure similar to that of the magnetic layer 115. In a case where the magnetic layer 115 includes a Co-based alloy, the first underlayer 114A and the second underlayer 114B include a material having a hexagonal close-packed (hcp) structure similar to that of the Co-based alloy, and a c-axis of that structure is preferably oriented in a direction perpendicular to the film surface (i.e., in the film thickness direction). One reason for this is that the orientation of the magnetic layer 115 is able to be enhanced and that the lattice constant matching between the second underlayer 114B and the magnetic layer 115 is able to be made relatively favorable. As the material having the hexagonal close-packed (hcp) structure, it is preferable to use a material containing Ru, and specifically a Ru simple substance or a Ru alloy is preferred. Examples of the Ru alloy include Ru alloy oxides such as Ru—SiO₂, Ru-TiO₂, and Ru-ZrO₂; the Ru alloy may be one of those described above. As the material having the hexagonal close-packed (hcp) structure configuring the first underlayer 114A and the second underlayer 114B, there may be included, in addition to those described above, for example, a Co-based alloy such as Co_{(100-y)}Cr_{y} (where y is within the range of 35≤y≤45), or, for example, a non-magnetic oxide such as [Co_{(100-y)}Cr_{y}]_{(100-z)}(MO₂)_{z} (where y and z are in the ranges of 35≤y≤45 and z≤10, and M is Si or Ti).

As described above, similar materials can be used as the materials of the first underlayer 114A and the second underlayer 114B. The intended effect differs, however, for each of the first underlayer 114A and the second underlayer 114B. Specifically, the second underlayer 114B has a film structure that promotes a granular structure of the magnetic layer 115 which serves as an upper layer on the underlayer, and the first underlayer 114A has a film structure with high crystalline orientation. In order to obtain such a film structure, the conditions for deposition such as sputtering conditions preferably differ for each of the first underlayer 114A and the second underlayer 114B.

The average thickness of the first underlayer 114A is preferably 3 nm or more and 15 nm or less, and more preferably 5 nm or more and 10 nm or less. The average thickness of the second underlayer 114B is preferably 7 nm or more and 100 nm or less, and more preferably 40 nm or more and 80 nm or less.

### (Magnetic Layer)

The magnetic layer (also referred to as a recording layer) 115 may be a perpendicular magnetic recording layer in which a magnetic material is vertically oriented. From the viewpoint of improving the recording density, the magnetic layer 115 is preferably a granular magnetic layer containing a Co-based alloy. This granular magnetic layer includes ferromagnetic crystalline particles containing a Co-based alloy and non-magnetic particle boundaries (non-magnetic material) that surround the ferromagnetic crystalline particles. More specifically, the granular magnetic layer includes columns (columnar crystals) containing a Co-based alloy, and non-magnetic particle boundaries (e.g., oxides such as SiO₂) that surround the columns and magnetically separate the column. This structure can constitute the magnetic layer 115 that has a structure with the respective columns magnetically separated.

The Co-based alloy has a hexagonal close-packed (hcp) structure, and the c-axis thereof is oriented in a direction perpendicular to the film surface (film thickness direction). As the Co-based alloy, it is preferable to use a CoCrPt-based alloy containing at least Co, Cr, and Pt. The CoCrPt-based alloy may further contain an additive element. Examples of the additive element include one or more elements selected from the group consisting of Ni, Ta, and the like.

The non-magnetic particle boundaries that surround the ferromagnetic crystalline particles include a non-magnetic metal material. Here, the metal is considered to encompass semimetal. As the non-magnetic metal material, for example, at least one of a metal oxide or a metal nitride can be used; from the viewpoint of keeping the granular structure more stable, it is preferable to use a metal oxide. Examples of the metal oxide include a metal oxide containing at least one or more elements selected from the group consisting of Si, Cr, Co, Al, Ti, Ta, Zr, Ce, Y, Hf, and the like, and a metal oxide containing at least a Si oxide (i.e., SiO₂) is preferred. Specific examples of the metal oxide include SiO₂, Cr₂O₃, CoO, Al₂O₃, TiO₂, Ta₂O₅, ZrO₂, HfO₂, or the like. Examples of the metal nitride include a metal nitride containing at least one or more elements selected from the group consisting of Si, Cr, Co, Al, Ti, Ta, Zr, Ce, Y, Hf and the like. Specific examples of the metal nitride include SiN, TiN, AlN, or the like.

The CoCrPt-based alloy included in the ferromagnetic crystalline particles and the Si oxide included in the non-magnetic particle boundaries preferably have an average composition represented by the following expression (1). One reason for this is that it is possible to achieve a saturation magnetization amount Ms that is able to suppress the influence of the diamagnetic field and ensure a sufficient reproduced output, thereby making it possible to further achieve an improvement in the recording and reproducing characteristics.

(CoxPtyCr100-x-y)100-z-(SiO₂)z (1)
(In the formula (1), x, y, and z are values within the range of 69≤x≤75, 10≤y≤16, and 9≤z≤12.)

It is to be noted that the composition mentioned above is able to be determined as follows. A depth profile analysis of the magnetic layer 115 is made by AES while ion-milling the magnetic recording medium 110 from the side of the magnetic layer 115, thereby determining the average composition (average atomic ratio) of Co, Pt, Cr, Si, and O in the film thickness direction.

The average thickness tm [nm] of the magnetic layer 115 is preferably 9 nm≤tm≤90 nm, more preferably 9 nm≤tm≤20 nm, and still more preferably 9 nm≤tm≤15 nm. The average thickness tm of the magnetic layer 115 being within the above-mentioned numerical ranges makes it possible to improve the electromagnetic conversion characteristics.

In addition, the average particle volume of the magnetic powders of the magnetic layer 115 formed by a sputtering method is desirably 350 nm³ or more and 1800 nm³ or less. In order to determine the average particle volume of the magnetic powders of the magnetic layer 115, a surface of the magnetic layer 115 is first exposed by etching processing, and the surface is observed by TEM. From the observed image, a diameter R115 of the magnetic particles on the surface of the magnetic layer 115 is measured. Next, a cross-section of the magnetic layer 115 is formed by FIB, for example, and a thickness t115 is measured for the magnetic layer 115 from an image of the cross-section obtained by TEM. Thereafter, the particle volume is determined from the following expression.

(Particle volume)=((R115)/2)²×π×(t115)

This is repeated for several locations to calculate an average value of particle volumes thereof.

### (Protective Layer)

A protective layer 116 includes, for example, a carbon material or silicon dioxide (SiO₂), and preferably includes a carbon material from the viewpoint of film strength of the protective layer 116. Examples of the carbon material include graphite, diamond-like carbon (Diamond-Like Carbon: DLC), diamond, or the like.

### (Lubricating Layer)

The lubricating layer 117 includes at least one lubricant. The lubricating layer 117 may further include various additives, e.g., rust inhibitors, or the like, as needed. The lubricant has at least two carboxyl groups and one ester bond, and includes at least one carboxylic acid compound represented by the following general formula (1). The lubricant may further include a lubricant of a type other than the carboxylic acid compound represented by the following general formula (1).

### General Formula (1):

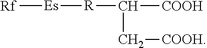 [0262] (In the formula, Rf denotes an unsubstituted or substituted, and saturated or unsaturated fluorine-containing hydrocarbon group or hydrocarbon group, Es denotes an ester bond, and R, which may be omitted, denotes an unsubstituted or substituted, and saturated or unsaturated hydrocarbon group.)

The above-described carboxylic acid compound is preferably represented by the following general formula (2) or (3).

### General Formula (2):

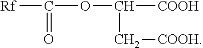 [0265] (In the formula, Rf denotes an unsubstituted or substituted, and saturated or unsaturated fluorine-containing hydrocarbon group or hydrocarbon group.) General Formula (3):

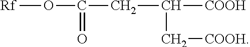

(In the formula, Rf denotes an unsubstituted or substituted, and saturated or unsaturated fluorine-containing hydrocarbon group or hydrocarbon group.)

The lubricant preferably includes one or both of the carboxylic acid compounds represented by the general formulae (2) and (3) mentioned above.

When a lubricant including a carboxylic acid compound represented by the general formula (1) is applied to the magnetic layer 115, the protective layer 116, or the like, a lubricating action is developed by cohesive force between fluorine-containing hydrocarbon groups or hydrocarbon groups Rf that are hydrophobic groups. In a case where the Rf group is a fluorine-containing hydrocarbon group, the total carbon number is preferably 6 to 50, and the total carbon number of the fluorinated hydrocarbon group is preferably 4 to 20. The Rf group may be, for example, a saturated or unsaturated, and linear, branched, or cyclic hydrocarbon group, but can preferably be a saturated linear hydrocarbon group.

For example, in a case where the Rf group is a hydrocarbon group, the Rf group is desirably a group represented by the following general formula (4). General Formula (4):

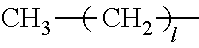

(In the general formula (4), 1 denotes an integer selected from the range of8 to 30, more desirably 12 to 20.)

In addition, in a case where the Rf group is a fluorine-containing hydrocarbon group, the Rf group is desirably a group represented by the following general formula (5).

### General Formula (5):

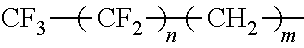 [0273] (In the general formula (5), m and n each denote an integer selected, independently of each other, from the following ranges: m=2 to 20, n=3 to 18, more desirably m=4 to 13, n=3 to 10.)

The fluorinated hydrocarbon group may be concentrated on one site within a molecule as mentioned above, or dispersed as in the following general formula (6), and may be not only —CF₃ or —CF₂—, but also —CHF₂, —CHF—, or the like.

### General Formula (6):

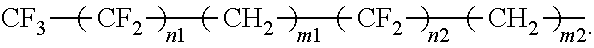 [0276] (In the general formulae (5) and (6), n1+n2=n, m1+m2=m.)

The carbon numbers are limited as mentioned above in the general formulae (4), (5), and (6), because when the number of carbon atoms configuring the alkyl group or the fluorine-containing alkyl group (l, or the sum of m and n) is equal to or more than the lower limit mentioned above, the length of the group reaches an appropriate length, thereby effectively exhibiting the cohesive force between the hydrophobic groups, developing a favorable lubricating action, and improving friction/abrasion durability. In addition, one reason for this is that, when the number of carbon atoms is equal to or less than the upper limit mentioned above, the solubility of the lubricant including the carboxylic acid compound in a solvent is kept favorable.

In particular, the Rf group in the general formulae (1), (2), and (3) is, when the group contains a fluorine atom, effective for a reduction in a friction coefficient, an improvement in traveling performance, and the like. It is, however, preferable to provide a hydrocarbon group between the fluorine-containing hydrocarbon group and the ester bond, thereby, with the space between the fluorine-containing hydrocarbon group and the ester bond, ensuring the stability of the ester bond for prevention of hydrolysis.

In addition, the Rf group may have a fluoroalkyl ether group or a perfluoropolyether group.

The R group in the general formula (1) may be omitted, but, if any, is preferably a hydrocarbon chain having a relatively small number of carbon atoms.

In addition, the Rf group or the R group contains, as a constituent element, one or a plurality of elements selected from nitrogen, oxygen, sulfur, phosphorus, and halogen, and may further have, in addition to the already described functional groups, a hydroxyl group, a carboxyl group, a carbonyl group, an amino group, an ester bond, or the like.

Specifically, the carboxylic acid compound represented by the general formula (1) is preferably at least one of the following compounds. That is, the lubricant preferably contains at least one of the following compounds.
CF₃(CF₂)₇(CH₂)₁₀COOCH(COOH)CH₂COOH
CF₃(CF₂)₃(CH₂)₁₀COOCH(COOH)CH₂COOH
C₁₇H₃₅COOCH(COOH)CH₂COOH
CF₃(CF₂)₇(CH₂)₂OCOCH₂CH(C₁₈H₃₇)COOCH(COOH)CH₂COOH
CF₃(CF₂)₇COOCH(COOH)CH₂COOH
CHF₂(CF₂)₇COOCH(COOH)CH₂COOH
CF₃(CF₂)₇(CH₂)₂OCOCH₂CH(COOH)CH₂COOH
CF₃(CF₂)₇(CH₂)₆OCOCH₂CH(COOH)CH₂COOH
CF₃(CF₂)₇(CH₂)₁₁OCOCH₂CH(COOH)CH₂COOH
CF₃(CF₂)₃(CH₂)₆OCOCH₂CH(COOH)CH₂COOH
C₁₈H₃₇OCOCH₂CH(COOH)CH₂COOH
CF₃(CF₂)₇(CH₂)₄COOCH(COOH)CH₂COOH
CF₃(CF₂)₃(CH₂)₄COOCH(COOH)CH₂COOH
CF₃(CF₂)₃(CH₂)₇COOCH(COOH)CH₂COOH
CF₃(CF₂)₃(CH₂)₁₀COOCH(COOH)CH₂COOH
CF₃(CF₂)₂(CH₂)₁₁COOCH(COOH)CH₂COOH
CF₃(CF₂)₅(CH₂)₁₀COOCH(COOH)CH₂COOH
CF₃(CF₂)₇CH(C₉H₁₉)CH₂CH═CH(CH₂)₇COOCH(COOH)CH₂COOH
CF₃(CF₂)₇CH(C₉H₁₃)(CH₂)₇COOCH(COOH)CH₂COOH
CH₃(CH₂)₃(CH₂CH₂CH(CH₂CH₂(CF₂)₉CF₃))₂(CH₂)₇COOCH(COOH)CH₂COOH

The carboxylic acid compound represented by the general formula (1), which is soluble in a non-fluorine solvent exerting a low burden on the environment, has the advantage of, for example, allowing for operations such as coating, dipping, and spraying to be performed with the use of a general-purpose solvent such as a hydrocarbon-based solvent, a ketone-based solvent, an alcohol-based solvent, and an ester-based solvent. Specifically, examples of the general-purpose solvent can include solvents such as hexane, heptane, octane, decane, dodecane, benzene, toluene, xylene, cyclohexane, methyl ethyl ketone, methyl isobutyl ketone, methanol, ethanol, isopropanol, diethyl ether, tetrahydrofuran, dioxane, and cyclohexanone.

In a case where the protective layer 116 includes a carbon material, application of the carboxylic acid compound mentioned above as a lubricant onto the protective layer 116 allows two carboxyl groups and at least one ester linking group, which serve as polar group sites of a lubricant molecule, to be adsorbed onto the protective layer 116, thereby enabling the cohesive force between the hydrophobic groups to form the lubricating layer 117 which particularly has favorable durability.

It is to be noted that the lubricant is not only held as the lubricating layer 117 on the surface of the magnetic recording medium 110 as described above, but may also be included and held in the layers such as the magnetic layer 115 and the protective layer 116 configuring the magnetic recording medium 110.

### (Back Layer)

The back layer 118 may have a configuration similar to that of the back layer 14 according to the first embodiment.

All of the physical properties of the magnetic recording medium 10 and the measurement method thereof described in the foregoing first embodiment are applicable to the physical properties of the magnetic recording medium 110 and the measurement method thereof of the present embodiment. For example, the average thickness of the magnetic recording medium 110 and the measurement method thereof are similar to the average thickness of the magnetic recording medium 10 and the measurement method thereof. The same applies to parameters representing other physical properties such as the coercivity Hc, the squareness ratio, and the moisture content rate WA.

### 3-3. Configuration of Sputtering Apparatus

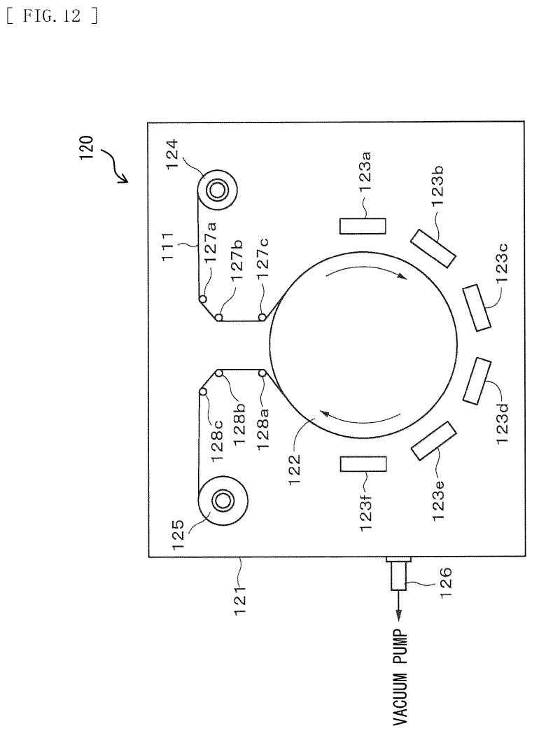

Hereinafter, description is given, with reference to FIG. 12, of an example of a configuration of a sputtering apparatus 120 for use in the manufacture of the magnetic recording medium 110. The sputtering apparatus 120 is a continuous winding-type sputtering apparatus for use in deposition of the SUL 112, the first seed layer 113A, the second seed layer 113B, the first underlayer 114A, the second underlayer 114B, and the magnetic layer 115. The sputtering apparatus 120 includes, as illustrated in FIG. 12, a deposition chamber 121, a drum 122 which is a metal can (rotating body), cathodes 123a to 123f, a supply reel 124, a take-up reel 125, and a plurality of guide rollers 127a to 127c and 128a to 128c. The sputtering apparatus 120 is, for example, a DC (direct current) magnetron sputtering-type apparatus, but the sputtering type is not limited to this type.

The deposition chamber 121 is coupled to an unillustrated vacuum pump via an exhaust port 126, and the atmosphere in the deposition chamber 121 is set by the vacuum pump to a predetermined degree of vacuum. The drum 122 having a rotatable configuration, the supply reel 124, and the take-up reel 125 are disposed inside the deposition chamber 121. Inside the deposition chamber 121, the plurality of guide rollers 127a to 127c is provided for guiding the transfer of a base layer 111 between the supply reel 124 and the drum 122, and the plurality of guide rollers 128a to 128c is provided for guiding the transfer of the base layer 111 between the drum 122 and the take-up reel 125. Upon sputtering, the base layer 111 unwound from the supply reel 124 is wound around the take-up reel 125 via the guide rollers 127a to 127c, the drum 122, and the guide rollers 128a to 128c. The drum 122 has a cylindrical shape, and the elongated base layer 111 is transferred along the peripheral cylindrical surface of the drum 122. The drum 122 is provided with an unillustrated cooling mechanism, and cooled to, for example, about −20° C. upon sputtering. Inside the deposition chamber 121, the plurality of cathodes 123a to 123f is disposed to face the peripheral surface of the drum 122. Respective targets are set for these cathodes 123a to 123f. Specifically, the respective targets for depositing the SUL 112, the first seed layer 113A, the second seed layer 113B, the first underlayer 114A, the second underlayer 114B, and the magnetic layer 115 are set for the cathodes 123a, 123b, 123c, 123d, 123e, and 123f. With these cathodes 123a to 123f, multiple kinds of films, i.e., the SUL 112, the first seed layer 113A, the second seed layer 113B, the first underlayer 114A, the second underlayer 114B, and the magnetic layer 115 are simultaneously deposited.

The sputtering apparatus 120 having the above-described configuration is able to continuously deposit, by a roll-to-roll method, the SUL 112, the first seed layer 113A, the second seed layer 113B, the first underlayer 114A, the second underlayer 114B, and the magnetic layer 115.

### 3-4. Method of Manufacturing Magnetic Recording Medium 110

The magnetic recording medium 110 may be manufactured, for example, as follows.

First, the sputtering apparatus 120 illustrated in FIG. 12 is used to deposit the SUL 112, the first seed layer 113A, the second seed layer 113B, the first underlayer 114A, the second underlayer 114B, and the magnetic layer 115 sequentially on a front surface of the base layer 111. Specifically, the deposition is performed as follows. First, the deposition chamber 121 is evacuated until reaching a predetermined pressure. Thereafter, the targets set on the cathodes 123a to 123f are sputtered while introducing a process gas such as an Ar gas into the deposition chamber 121. This allows the SUL 112, the first seed layer 113A, the second seed layer 113B, the first underlayer 114A, the second underlayer 114B, and the magnetic layer 115 to be sequentially deposited on the front surface of the traveling base layer 111.

The atmosphere of the deposition chamber 121 upon sputtering is set to, for example, about 1×10−5 Pa to 5×10−5 Pa. It is possible to control the film thicknesses and characteristics of the SUL 112, the first seed layer 113A, the second seed layer 113B, the first underlayer 114A, the second underlayer 114B, and the magnetic layer 115 by adjusting the tape line speed at which the base layer 111 is wound up, the pressure (sputtering gas pressure) of a process gas such as an Ar gas to be introduced upon sputtering, input power, and the like.

Next, the protective layer 116 is deposited on the magnetic layer 115. As a method of depositing the protective layer 116, for example, a chemical vapor deposition (Chemical Vapor Deposition: CVD) method or a physical vapor deposition (Physical Vapor Deposition: PVD) method can be used.

Next, a coating material for back layer deposition is prepared by kneading and dispersing a binder, inorganic particles, a lubricant, and the like in a solvent. Next, the back layer 118 is deposited on a back surface of the base layer 111 by applying a coating material for back layer deposition on the back surface of the base layer 111 and drying the coating material.

Next, for example, a lubricant is applied onto the protective layer 116 to deposit the lubricating layer 117. As a method of applying the lubricant, various coating methods can be used, such as gravure coating and dip coating, for example. Next, the magnetic recording medium 110 is cut to have a predetermined width, as needed. Thus, the magnetic recording medium 110 illustrated in FIG. 11 is obtained.

### 3-5. Effects

Also in the present embodiment, when the weight of the magnetic recording medium 110 is set to one, the rate of the moisture content (moisture content rate WA) contained in the magnetic recording medium 110 in state of being stored in an environment of 23° C. and 45% RH for 24 hours or more is set to 0.64 wt % or less. Therefore, effects similar to those of the magnetic recording medium 10 of the foregoing first embodiment are expectable.

### 3-6. Modification Example

The magnetic recording medium 110 may further include an underlayer between the substrate 111 and the SUL 112. The SUL 112 has an amorphous state, and thus has no role in promoting epitaxial growth of a layer formed on the SUL 112. However, the SUL 112 is required not to disturb the crystalline orientations of the first underlayer 114A and the second underlayer 114B formed on the SUL 112. To that end, the soft magnetic material preferably has a fine structure that forms no column. However, in a case of being largely affected by degassing of moisture or the like from the substrate 111, there is a possibility that the soft magnetic material may be coarsened, thereby disturbing the crystalline orientations of the first underlayer 114A and the second underlayer 114B formed on the SUL 112. In order to suppress the influence of the degassing of moisture or the like from the substrate 111, it is preferable to provide, between the substrate 111 and the SUL 112, an underlayer that includes an alloy containing Ti and Cr and has an amorphous state, as described above. As a specific configuration of the underlayer, a configuration can be adopted which is similar to that of the first seed layer 113A.

The magnetic recording medium 110 may not include at least one of the second seed layer 113B or the second underlayer 114B. From the viewpoint of improving the SNR, however, it is more preferable to include both of the second seed layer 113B and the second underlayer 114B.

The magnetic recording medium 110 may include an APC-SUL (Antiparallel Coupled SUL) instead of the SUL 112 of the single-layer structure.

### 4. EXAMPLES

Hereinafter, specific description is given of the present disclosure with reference to examples. However, the present disclosure is not limited to these examples.

In the following examples and comparative examples, the moisture content rate WA, the average thickness of the substrate, the average thickness of the magnetic recording medium, the arithmetic mean roughness Ra of the surface of the magnetic layer, the temperature expansion coefficient α, the humidity expansion coefficient β, and the average particle volume of the magnetic powders are the values determined by the measurement method described in the foregoing embodiment.

### Example 1

A magnetic recording medium of Example 1 was obtained as follows.

### (Preparation Step of Coating Material for Forming Magnetic Layer)

The coating material for forming a magnetic layer was prepared as follows. First, a first composition of the following formulation was kneaded by an extruder. Next, the kneaded first composition and a second composition of the following formulation were added to a stirring tank equipped with a disperser to perform preliminary mixing. Subsequently, sand mill mixing was further performed, and filter treatment was performed to prepare the coating material for forming a magnetic layer.

### (First Composition)

Barium ferrite nanoparticle powders: 100 parts by mass
Vinyl chloride-based resin (cyclohexanone solution 30% by mass): 61 parts by mass (Degree of polymerization: 300, Mn=10000, containing OSOK=0.07 mmol/g and secondary OH=0.3 mmol/g as polar groups)
Aluminum oxide powder: 5 parts by mass (α-Al₂O₃, average particle diameter 0.2 μm)
Carbon black: 2 parts by mass (Manufactured by Tokai Carbon Co., Ltd., trade name: Seast TA)

### (Second Composition)

Vinyl chloride-based resin: 3.7 parts by mass (Resin solution: resin content 30% by mass, cyclohexanone 70% by mass)
n-Butyl stearate: 2 parts by mass
Methyl ethyl ketone: 121.3 parts by mass
Toluene: 121.3 parts by mass
Cyclohexanone: 60.7 parts by mass

Finally, as a curing agent, 4 parts by mass of polyisocyanate (trade name: Coronate L, manufactured by Nippon Polyurethane Industry Co., Ltd.) and 2 parts by mass of myristic acid were added to the coating material for forming a magnetic layer, prepared in the same manner as described above.

### (Preparation Step of Coating Material for Forming Underlayer)

A coating material for forming an underlayer was prepared as follows. First, a third composition of the following formulation was kneaded with an extruder. Next, the kneaded third composition and a fourth composition of the following formulation were added to a stirring tank equipped with a disperser to perform preliminary mixing. Subsequently, the mixture was further mixed with a sand mill, and subjected to filter treatment to prepare the coating material for forming an underlayer.

### (Third Composition)

Acicular iron oxide powder: 100 parts by mass (α-Fe₂O₃, average major axis length 0.15 μm)
Vinyl chloride-based resin: 55.6 parts by mass (Resin solution: resin content 30% by mass, cyclohexanone 70% by mass)
Carbon black: 10 parts by mass (Average particle diameter 20 nm)

### (Fourth Composition)

Polyurethane-based resin UR8200 (manufactured by Toyobo Co., Ltd.): 18.5 parts by mass
n-Butyl stearate: 2 parts by mass
Methyl ethyl ketone: 108.2 parts by mass
Toluene: 108.2 parts by mass
Cyclohexanone: 18.5 parts by mass

Finally, as a curing agent, 4 parts by mass of polyisocyanate (trade name: Coronate L, manufactured by Nippon Polyurethane Industry Co., Ltd.) and 2 parts by mass of myristic acid were added to the coating material for forming an underlayer, prepared in the same manner as described above.

### (Preparation Step of Coating Material for Forming Back Layer)

A coating material for forming a back layer was prepared as follows. The following raw materials were mixed in a stirring tank equipped with a disperser, and subjected to filter treatment to prepare a coating material for forming a back layer.
Carbon black (manufactured by Asahi Carbon Co., Ltd., trade name: #80): 100 parts by mass
Polyester polyurethane: 100 parts by mass (Trade name: N-2304, manufactured by Nippon Polyurethane Industry Co., Ltd.)
Methyl ethyl ketone: 500 parts by mass
Toluene: 400 parts by mass
Cyclohexanone: 100 parts by mass

### (Deposition Step)

The coating material prepared as described above was used to form, on a polymer film as the substrate, an underlayer having an average thickness of 1.0 μm and a magnetic layer having an average thickness tm of 90 nm, as follows. It is to be noted that a PEN (polyethylene naphthalate) film having an average thickness of 3.6 μm was used for the polymer film. First, an underlayer was formed on the polymer film by applying the coating material for forming an underlayer onto the polymer film and drying the coating material. Next, a magnetic layer was formed on the underlayer by applying the coating material for forming a magnetic layer onto the underlayer and drying the coating material. It is to be noted that, upon drying the coating material for forming a magnetic layer, the magnetic field of the magnetic powders was oriented by a solenoid coil in the thickness direction of the film. In addition, the time of applying the magnetic field to the coating material for forming a magnetic layer was adjusted to set the squareness ratio S2 in the thickness direction (vertical direction) of the magnetic recording medium to 65%.

Subsequently, a back layer having an average thickness tb of 0.6 μm was applied to the polymer film with the underlayer and the magnetic layer formed, and dried. Then, the polymer film with the underlayer, the magnetic layer, and the back layer formed was subjected to curing treatment. Subsequently, a calendering processing was performed to planarize the surface of the magnetic layer. At this time, after the condition (temperature) for the calendering processing was adjusted to allow an interlayer friction coefficient β between the magnetic surface and the back surface to be about 0.5, re-curing treatment was performed to obtain a magnetic recording medium having an average thickness tT of 5.2 μm.

### (Dry Processing)

Further, the obtained magnetic recording medium was passed through the inside of a drying furnace (length: 30 m) set at 110° C. at a speed of 200 m/min to be rewound around a core, thereby volatilizing the moisture.

### (Cutting Step)

The magnetic recording medium obtained as described above was cut to have a width of ½ inches (12.65 mm). Thus, an intended elongated magnetic recording medium (average thickness: 5.2 μm) was obtained as Example 1.

It is to be noted that, in the obtained magnetic recording medium of Example 1 in a state of being stored in an environment of 23° C. and 45% RH for 24 hours or more, the moisture content rate WA was 0.639 wt %, the surface roughness Ra of the magnetic layer was 1.9 nm, the temperature expansion coefficient α was 11.6 [ppm/° C.], the humidity expansion coefficient β was 6.9 [ppm/% RH], and the average particle volume V of the barium ferrite magnetic powders of the magnetic layer was 1600 nm³.

### Example 2

A magnetic recording medium of Example 2 was obtained as follows.

### (Polymer Film Rewinding Processing)

First, processing was performed to rewind an elongated polymer film as a substrate around a core while traveling inside a vacuum furnace. It is to be noted that a PET (polyethylene terephthalate) film having an average thickness of 5.3 μm was used as a polymer film. Specifically, a PET film having a total length of 4000 m was wound around the core while traveling at a speed of 50 m/min.

### (SUL Deposition Step)

Next, a CoZrNb layer having an average thickness of 10 nm was deposited as an SUL on a surface of a substrate (PET film) subjected to the rewinding processing described above, under the following deposition conditions.
Deposition method: DC magnetron sputtering method
Target: CoZrNb target
Gas species: Ar
Gas pressure: 0.1 Pa

### (Deposition Step for First Seed Layer)

Next, a TiCr layer having an average thickness of 5 nm was deposited as a first seed layer on the CoZrNb layer under the following deposition conditions.
Sputtering method: DC magnetron sputtering method
Target: TiCr target
Ultimate vacuum: 5-10-5 Pa
Gas species: Ar
Gas pressure: 0.5 Pa

### (Deposition Step for Second Seed Layer)

Next, a NiW layer having an average thickness of 10 nm was deposited as a second seed layer on the TiCr layer under the following deposition conditions.
Sputtering method: DC magnetron sputtering method
Target: NiW target
Ultimate vacuum: 5×10−5 Pa
Gas species: Ar
Gas pressure: 0.5 Pa

### (Deposition Step for First Underlayer)

Next, a Ru layer having an average thickness of 10 nm was deposited as a first underlayer on the NiW layer under the following deposition conditions.
Sputtering method: DC magnetron sputtering method
Target: Ru target
Gas species: Ar
Gas pressure: 0.5 Pa

### (Deposition Step for Second Underlayer)

Next, a Ru layer having an average thickness of 20 nm was deposited as a second underlayer on the Ru layer under the following deposition conditions.
Sputtering method: DC magnetron sputtering method
Target: Ru target
Gas species: Ar
Gas pressure: 1.5 Pa

### (Deposition Step for Magnetic Layer)

Next, a (CoCrPt)—(SiO2) layer having an average thickness of 9 nm was deposited as a magnetic layer on the Ru layer under the following deposition conditions.
Deposition method: DC magnetron sputtering method
Target: (CoCrPt)—(SiO2) target
Gas species. Ar
Gas pressure: 1.5 Pa

### (Deposition Step for Protective Layer)

Next, a carbon layer having an average thickness of 5 nm was deposited as a protective layer on the magnetic layer under the following deposition conditions.
Deposition method: DC magnetron sputtering method
Target: carbon target
Gas species: Ar
Gas pressure: 1.0 Pa

### (Deposition Step for Lubricating Layer)

Next, a lubricant was applied onto the protective layer to form a lubricating layer.

### (Deposition Step for Back Layer)

Next, a coating material for forming a back layer was applied to the surface of the substrate on a side opposite to the magnetic layer and dried to form a back layer having an average thickness tb of 0.3 μm. Thus, a magnetic recording medium having an average thickness tT of 5.7 μm was obtained.

### (Step of Cutting)

The magnetic recording medium obtained as described above was cut to have a width of ½ inches (12.65 mm). Thus, an intended elongated magnetic recording medium (average thickness: 5.7 μm) was obtained as Example 2.

It is to be noted that, in the obtained magnetic recording medium of Example 2 in a state of being stored in an environment of 23° C. and 45% RH for 24 hours or more, the moisture content rate WA was 0.285 wt %, the surface roughness Ra of the magnetic layer was 0.9 nm, the temperature expansion coefficient α was 11.7 [ppm/° C.], and the humidity expansion coefficient β was 1.8 [ppm/% RH].

### Example 3

Instead of performing rewinding processing inside the vacuum furnace, the polymer film as a substrate was stored for 24 h inside the vacuum furnace while being wound around the core. Thereafter, the respective layers, i.e., the SUL, the first seed layer, the second seed layer, the first underlayer, the second underlayer, the magnetic layer, the protective layer, the lubricating layer, and the back layer were deposited. It is to be noted that the PEN film having an average thickness of 4.0 μm was used as the polymer film. In the same manner as the foregoing Example 2 except these points, a magnetic recording medium (average thickness: 4.4 μm) was obtained as Example 3.

It is to be noted that, in the obtained magnetic recording medium of Example 3 in a state of being stored in an environment of 23° C. and 45% RH for 24 hours or more, the moisture content rate WA was 0.294 wt %, the surface roughness Ra of the magnetic layer was 1.2 nm, the temperature expansion coefficient α was 5.5 [ppm/° C.], and the humidity expansion coefficient β was −0.7 [ppm/% RH].

### Comparative Example 1

The PEN film having an average thickness of 4.0 μm was used for the polymer film as a substrate to produce a magnetic recording medium having an average thickness of 5.6 μm without performing dry processing between the calendering processing and the cutting step. In the same manner as the foregoing Example 1 except these points, a magnetic recording medium was obtained as Comparative Example 1. It is to be noted that, in the obtained magnetic recording medium of Comparative Example 1 in a state of being stored in an environment of 23° C. and 45% RH for 24 hours or more, the moisture content rate WA was 0.653 wt %, the surface roughness Ra of the magnetic layer was 1.8 nm, the temperature expansion coefficient α was 10.8 [ppm/° C.], the humidity expansion coefficient β was 7.5 [ppm/% RH], and the average particle volume V of the barium ferrite magnetic powders of the magnetic layer was 2500 nm³.

### Comparative Example 2

SPALTAN (registered trademark of Toray Industries, Inc.), which is a PET film, containing a high Tg material having an average thickness of 4.0 μm was used for the polymer film as a substrate to produce a magnetic recording medium having an average thickness of 5.6 μm without performing dry processing between the calendering processing and the cutting step. In the same manner as the foregoing Example 2 except these points, a magnetic recording medium was obtained as Comparative Example 1. It is to be noted that, in the obtained magnetic recording medium of Comparative Example 2 in a state of being stored in an environment of 23° C. and 45% RH for 24 hours or more, the moisture content rate WA was 0.658 wt %, the surface roughness Ra of the magnetic layer was 1.9 nm, the temperature expansion coefficient α was 13.0 [ppm/° C.], the humidity expansion coefficient β was 10.6 [ppm/% RH], and the average particle volume V of the barium ferrite magnetic powders of the magnetic layer was 2500 nm³.

### Comparative Example 3

In the same manner as the foregoing Example 1 except that the dry processing is not performed between the calendering processing and the cutting step, a magnetic recording medium was obtained as Comparative Example 3. It is to be noted that, in the obtained magnetic recording medium of Comparative Example 3 in a state of being stored in an environment of 23° C. and 45% RH for 24 hours or more, the moisture content rate WA was 0.652 wt %, the surface roughness Ra of the magnetic layer was 1.9 nm, the temperature expansion coefficient α was 11.5 [ppm/° C.], the humidity expansion coefficient β was 7.1 [ppm/% RH], and the average particle volume V of the barium ferrite magnetic powders of the magnetic layer was 1600 nm³.

### [Evaluation]

The respective magnetic recording media of Examples 1 to 3 and Comparative Examples 1 to 3 obtained as described above were evaluated as follows.

### (Presence or Absence of Condensation)

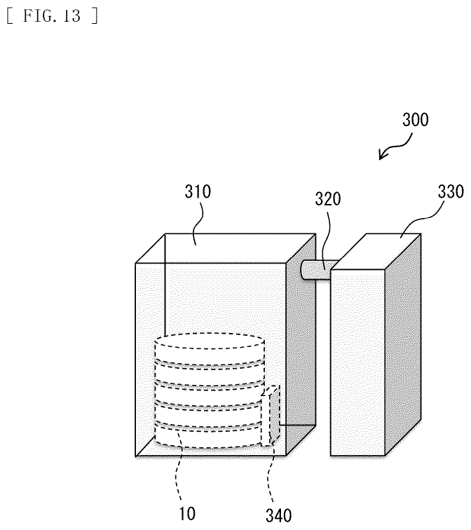

An environmental testing apparatus 300 illustrated in FIG. 13 was used to investigate whether or not condensation occurred on the surface of each of the magnetic recording media when the temperature environment was changed. The environmental testing apparatus 300 includes, for example, a constant temperature reservoir 310 having a space in which a sample of the magnetic recording medium is placed, a valve 320 provided at a side part thereof, an air-conditioned room 330 that supplies the constant temperature reservoir 310 with air of which temperature and humidity are controlled via the valve 320, and a thermo-hygrometer 340 provided in the space inside the constant temperature reservoir 310.

To evaluate the presence or absence of condensation, a sample of a magnetic recording medium is first placed inside the constant temperature reservoir 310, and then the temperature/humidity environment inside the constant temperature reservoir 310 is set to 23° C. and 45% RH. At that time, the valve 320 is in an open state. This state is held for 24 hours (step 1).

Next, the valve 320 is closed, and the temperature of the constant temperature reservoir 310 is set to 60° C. This state is held for 24 hours (step 2).

Next, the constant temperature reservoir 310 is set to 5° C. while the valve 320 remains closed. This state is held for 24 hours (step 3).

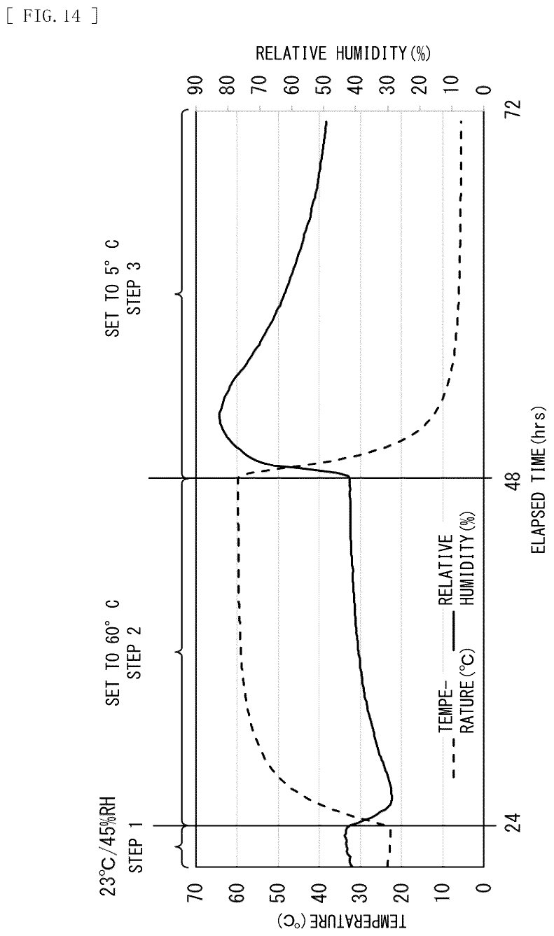

After 24 hours have elapsed, confirmation is made as to whether or not there is condensation inside the constant temperature reservoir 310. It is to be noted that FIG. 14 exhibits changes in the temperature/humidity environment inside the constant temperature reservoir 310 with respect to elapsed time (actual values measured by the thermo-hygrometer 340) in a test for evaluating the presence or absence of the occurrence of condensation. In addition, Table 1 exhibits evaluation results of the presence or absence of the occurrence of condensation in a summarized manner together with other physical properties.

TABLE 1

| | | | | | Magnetic | | |
|---|---|---|---|---|---|---|---|
| | | | | | Recording | | Magnetic |
| | Moisture | | | Substrate | Medium | | Layer |
| | Content | Presence or | | Average | Average | Material | Surface |
| | Rate | Absence of | Deposition | Thickness | Thickness | of | Roughness |
| | [wt %] | Condensation | Method | [μm] | [μm] | Substrate | Ra [μm] |
| Example 1 | 0.639 | Absent | Coating | 3.6 | 5.2 | PEN | 1.9 |
| | | (dissipated 20 | | | | | |
| | | hours later) | | | | | |
| Example 2 | 0.285 | Absent | Sputtering | 5.3 | 5.7 | PEN | 0.9 |
| | | (dissipated 8 | | | | | |
| | | hours later) | | | | | |
| Example 3 | 0.294 | Absent | Sputtering | 4 | 4.4 | PEN | 1.2 |
| | | (dissipated 8 | | | | | |
| | | hours later) | | | | | |
| Comparative | 0.653 | Present | Coating | 4 | 5.6 | PEN | 1.8 |
| Example 1 | | (remains even | | | | | |
| | | after 24 hours) | | | | | |
| Comparative | 0.658 | Present | Coating | 4 | 5.6 | SPALTAN | 1.9 |
| Example 2 | | (remains even | | | | | |
| | | after 24 hours) | | | | | |
| Comparative | 0.652 | Present | Coating | 3.6 | 5.2 | PEN | 1.9 |
| Example 3 | | (remains even | | | | | |
| | | after 24 hours) | | | | | |

| | Temperature | Humidity | | | |
|---|---|---|---|---|---|
| | Expansion | Expansion | Configuration | Configuration | |
| | Coefficient α | Coefficient β | of Magnetic | of Magnetic | |
| | [ppm/° C.] | [ppm/% RH] | Layer | Layer | Notes |
| Example 1 | 11.6 | 6.9 | BaFe | Binder | Passed through drying |
| | | | 1600 nm³ | 16.7 wt % | furnace at 110° C. |
| | | | | | before cutting. |
| Example 2 | 11.7 | 1.8 | Five-Layer | — | Substrate is subjected |
| | | | Film | | to rewinding processing |
| | | | | | in vacuo. |
| Example 3 | 5.5 | −0.7 | Five-Layer | — | Substrate is stored |
| | | | Film | | for 24 hours in vacuo. |
| Comparative | 10.8 | 7.5 | BaFe | Binder | — |
| Example 1 | | | 2500 nm³ | 16.7 wt % | |
| Comparative | 13 | 10.6 | BaFe | Binder | — |
| Example 2 | | | 2500 nm³ | 16.7 wt % | |
| Comparative | 11.5 | 7.1 | BaFe | Binder | — |
| Example 3 | | | 1600 nm³ | 16.7 wt % | |

As exhibited in Table 1, no condensation was confirmed, in any of Examples 1 to 3, inside the constant temperature reservoir 310. Particularly, it was confirmed, in Example 1, that the condensation inside the constant temperature reservoir 310 was dissipated 20 hours after switching of the set temperature from 60° C. (step 2) to 5° C. (step 3). In addition, it was confirmed, in Examples 2 to 3, that the condensation inside the constant temperature reservoir 310 was dissipated 8 hours after switching of the set temperature from 60° C. (step 2) to 5° C. (step 3). The following is deduced from these results. That is, sufficiently removing moisture from a polymer film as a substrate before formation of the underlayer or the magnetic layer makes it possible to optimize a moisture amount of the magnetic recording medium in a state of being stored in an environment of 23° C. and 45% RH for 24 hours or more. As a result, even in a case where a temperature in the surrounding environment of the magnetic recording medium changes, it is possible for the magnetic recording medium to absorb and remove the moisture effectively, thus stabilizing a relative humidity in the surrounding environment and thus suppressing occurrence of condensation.

In contrast, condensation inside the constant temperature reservoir 310 was confirmed in any of Comparative Examples 1 to 3.

It is to be noted that, instead of using the environmental testing apparatus 300, the presence or absence of the occurrence of condensation may be observed as follows. First, a sample of the magnetic recording medium is placed in a sealable desiccator, with the humidity inside the desiccator being adjusted, and then the desiccator is sealed. At this time, the ratio between the inner volume of the desiccator and the volume of the sample of the magnetic recording medium is favorably conformed to the ratio between the actual magnetic recording cartridge volume and the volume of the magnetic recording medium to be accommodated in the magnetic recording cartridge. The desiccator in which the sample of the magnetic recording medium is sealed is placed in the constant temperature reservoir and the temperature of the constant temperature reservoir is adjusted to thereby change the temperature inside the desiccator.

Although the specific description has been given of the present disclosure with reference to the embodiments and modification examples thereof, the present disclosure is not limited to the embodiments and the like described above, and may be modified in a wide variety of ways.

For example, the configurations, methods, processes, shapes, materials, numerical values, and the like described in the above embodiments and modification examples thereof are merely examples, and different configurations, methods, processes, shapes, materials, numerical values, and the like may be used, as needed. Specifically, the magnetic recording medium of the present disclosure may include components other than the substrate, the underlayer, the magnetic layer, the back layer, and the barrier layer. In addition, the chemical formulae of the compounds or the like are representative examples, and are not limited to the valences and the like described above as long as the compounds with the same general names are employed.

Further, the configurations, methods, processes, shapes, materials, numerical values, and the like of the above-described embodiments and modification examples thereof may be combined with each other without departing from the spirit of the present disclosure.

Further, in the numerical value ranges described in stages herein, the upper limit value or the lower limit value of the numerical value range in any stage may be replaced with the upper limit value or the lower limit value of the numerical value range in another stage. Unless otherwise specified, the materials exemplified herein may be used alone, or two or more thereof may be used in combination.

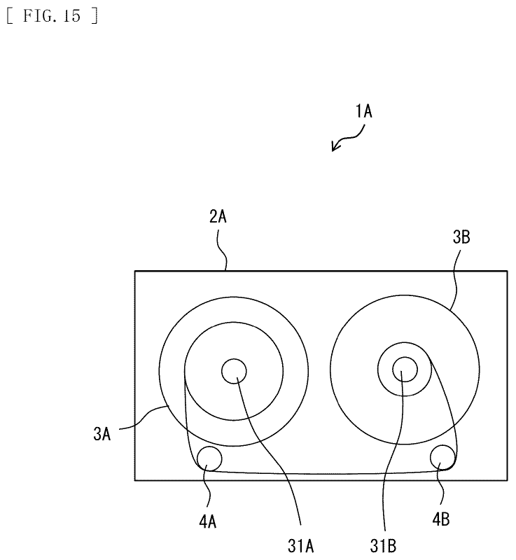

In addition, in the foregoing embodiments, the description has been given of the magnetic recording cartridge 1 in which one reel 3 is provided in one cartridge case 2, but the present disclosure is not limited thereto. For example, as in a magnetic recording cartridge 1A illustrated in FIG. 15, two reels 3A and 3B may be provided in one cartridge case 2A, and the magnetic recording medium 10 may be reciprocated between the reel 3A and the reel 3B. It is to be noted that the cartridge case 2A may be provided with guide rollers 4A and 4B for guiding the travel of the magnetic recording medium 10 as needed. For example, the reel 3A is rotationally driven by a spindle 31A in a recording/reproducing apparatus, and the reel 3B is rotationally driven by a spindle 31B in the recording/reproducing apparatus. In the magnetic recording cartridge 1A in the recording/reproducing apparatus, the rotation of the spindle 31A and the rotation of the spindle 31B interlock each other to thereby cause the magnetic recording medium 10 to move in a manner being wound around the reel 3B from a state of being wound around the reel 3A, for example. Thereafter, the spindle 31A and the spindle 31B rotate in opposite directions to thereby cause the magnetic recording medium 10 to move in a manner being wound around the reel 3A from a state of being wound around the reel 3B, for example.

As described above, according to the magnetic recording medium as an embodiment of the present disclosure, the rate of the moisture content contained in the magnetic recording medium in a state of being stored in an environment of 23° C. and 45% RH for 24 hours or more is set to 0.64 wt % or less, thus suppressing a variation in a relative humidity even in a case where the temperature environment changes rapidly. As a result, it is possible to suppress the occurrence of condensation, thus making it possible to perform stable traveling while favorably maintaining contact between the surface of the magnetic layer and the magnetic head, when performing recording on the magnetic recording medium and when performing reproducing from the magnetic recording medium. Thus, it is possible to achieve both an improvement in electromagnetic conversion characteristics as well as ensuring of high long-term reliability.

It is to be noted that the effects of the present disclosure are not limited thereto, and may be any of the effects described herein. In addition, the present technology may have the following configurations.

(1)

A magnetic recording medium having a tape-like shape, the magnetic recording medium including:
a substrate; and
a magnetic layer provided on the substrate, in which, when a weight of the magnetic recording medium is set to one, a rate of a moisture content contained in the magnetic recording medium in a state of being stored in an environment of 23° C. and 45% RH for 24 hours or more is 0.64 wt % or less.
   (2)

The magnetic recording medium according to (1), in which the rate of the moisture content contained in the magnetic recording medium is 0.2 wt % or more.

(3)

The magnetic recording medium according to (1) or (2), in which the rate of the moisture content contained in the magnetic recording medium is 0.3 wt % or less.

(4)

The magnetic recording medium according to any one of (1) to (3), in which
the magnetic layer includes magnetic powders containing hexagonal ferrite, and
an average particle volume of the magnetic powders is 400 nm³ or more and 1800 nm³ or less.
   (5)

The magnetic recording medium according to (4), in which the hexagonal ferrite includes at least one of Ba or Sr.

(6)

The magnetic recording medium according to any one of (1) to (5), in which the magnetic recording medium has an average thickness of 4.0 μm or more and 5.8 μm or less.

(7)

The magnetic recording medium according to any one of (1) to (6), in which the magnetic recording medium has an average thickness of 4.0 μm or more and 5.3 μm or less.

(8)

The magnetic recording medium according to any one of (1) to (7), in which a total surface area of a surface of the magnetic recording medium on a side of the magnetic layer is 6.3 m² or more and 25 m² or less.

(9)

The magnetic recording medium according to any one of (1) to (7), in which a total surface area of a surface of the magnetic recording medium on a side of the magnetic layer is 12 m² or more and 25 m² or less.

(10)

The magnetic recording medium according to any one of (1) to (7), in which a total surface area of a surface of the magnetic recording medium on a side of the magnetic layer is 15 m² or more and 25 m² or less.

(11)

A magnetic recording cartridge comprising the magnetic recording medium according to any one of (1) to (10).

(12)

A recording/reproducing apparatus that performs recording and reproducing on and from the magnetic recording medium according to any one of (1) to (10).

This application claims the benefit of Japanese Priority Patent Application JP2020-186854 filed with the Japan Patent Office on Nov. 9, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A magnetic recording medium having a tape-like shape, the magnetic recording medium comprising:
a substrate; and
a magnetic layer provided on the substrate, wherein, when a weight of the magnetic recording medium is set to one, a rate of a moisture content contained in the magnetic recording medium in a state of being stored in an environment of 23° C. and 45% RH for 24 hours or more is 0.64 wt % or less.

2. The magnetic recording medium according to claim 1, wherein the rate of the moisture content contained in the magnetic recording medium is 0.2 wt % or more.

3. The magnetic recording medium according to claim 1, wherein the rate of the moisture content contained in the magnetic recording medium is 0.3 wt % or less.

4. The magnetic recording medium according to claim 1, wherein
the magnetic layer includes magnetic powders containing hexagonal ferrite, and
an average particle volume of the magnetic powders is 400 nm³ or more and 1800 nm³ or less.

5. The magnetic recording medium according to claim 4, wherein the hexagonal ferrite includes at least one of Ba or Sr.

6. The magnetic recording medium according to claim 1, wherein the magnetic recording medium has an average thickness of 4.0 μm or more and 5.8 μm or less.

7. The magnetic recording medium according to claim 1, wherein the magnetic recording medium has an average thickness of 4.0 μm or more and 5.3 μm or less.

8. The magnetic recording medium according to claim 1, wherein a total surface area of a surface of the magnetic recording medium on a side of the magnetic layer is 6.3 m² or more and 25 m² or less.

9. The magnetic recording medium according to claim 1, wherein a total surface area of a surface of the magnetic recording medium on a side of the magnetic layer is 12 m² or more and 25 m² or less.

10. The magnetic recording medium according to claim 1, wherein a total surface area of a surface of the magnetic recording medium on a side of the magnetic layer is 15 m² or more and 25 m² or less.

11. A magnetic recording cartridge comprising:
a case; and
a reel around which a magnetic recording medium is wound, the reel being accommodated in the case,
the magnetic recording medium having a tape-like shape, the magnetic recording medium including
a substrate, and
a magnetic layer provided on the substrate, wherein, when a weight of the magnetic recording medium is set to one, a rate of a moisture content contained in the magnetic recording medium in a state of being stored in an environment of 23° C. and 45% RH for 24 hours or more is 0.64 wt % or less.

12. A recording/reproducing apparatus comprising:
a spindle on which a magnetic recording medium is configured to be mounted;
a drive device that drives the spindle; and
a magnetic head that performs recording and reproducing on and from the magnetic recording medium,
the magnetic recording medium having a tape-like shape, the magnetic recording medium including
a substrate, and
a magnetic layer provided on the substrate, wherein, when a weight of the magnetic recording medium is set to one, a rate of a moisture content contained in the magnetic recording medium in a state of being stored in an environment of 23° C. and 45% RH for 24 hours or more is 0.64 wt % or less.
